(19) United States
(12) Patent Application Publication
(10) Pub. No.: US 2016/0064024 A1
(43) Pub. Date: Mar. 3, 2016

(54) MAGNETIC TAPE

(71) Applicant: FUJIFILM CORPORATION, Tokyo (JP)

(72) Inventors: Tatsuo MIKAMI, Minami-ashigara-shi (JP); Junpei ISHIDA, Minami-ashigara-shi (JP); Wataru KIKUCHI, Minami-ashigara-shi (JP)

(73) Assignee: FUJIFILM CORPORATION, Tokyo (JP)

(21) Appl. No.: 14/837,184

(22) Filed: Aug. 27, 2015

(30) Foreign Application Priority Data
Aug. 29, 2014 (JP) 2014-176568

(51) Int. Cl. G11B 5/708; G11B 5/71; G11B 5/73; G11B 5/735; G11B 5/733

(52) U.S. Cl. CPC G11B 5/708; G11B 5/735; G11B 5/733; G11B 5/7305; G11B 5/71

(57) ABSTRACT

The magnetic tape comprises, on one surface of a nonmagnetic support, a nonmagnetic layer comprising nonmagnetic powder, lubricant, and binder, comprises, on a surface of the nonmagnetic layer, a magnetic layer comprising magnetic powder, lubricant, and binder, and comprises, on the opposite surface of the nonmagnetic support from the surface on which the nonmagnetic layer and magnetic layer are present, a backcoat layer comprising nonmagnetic powder, lubricant, and binder, wherein the contact angle for water of a surface of the magnetic layer ranges from 95° to 100°, and the contact angle for water of a surface of the backcoat layer ranges from 95° to 100°.

### CROSS-REFERENCE TO RELATED APPLICATIONS

This application claims priority under 35 U.S.C 119 to Japanese Patent Application No. 2014-176568 filed on Aug. 29, 2014. The above application is hereby expressly incorporated by reference, in its entirety.

### BACKGROUND OF THE INVENTION

1. Field of the Invention

The present invention relates to a magnetic tape.

2. Discussion of the Background

Magnetic recording media exist in the forms of tapes and disks. Magnetic recording media in the form of tapes, that is, magnetic tapes, are mainly used for storage applications such as data backup.

In recording and reproducing signals on magnetic tapes, a magnetic tape is normally run through a drive to cause the surface of the tape (surface of the magnetic layer) to come into contact (slide against) a head. However, when repeated running is conducted in a state with a high coefficient of friction during sliding of the surface of the magnetic layer against the head, the running may become unstable, causing an increase in noise. Portions of the surface of the magnetic layer and the head may be shaved off, generating shavings that may cause variation in the output due to spacing (spacing loss). As a result, the signal-to-noise ratio (SNR) may end up dropping. Because of the above, in magnetic tapes, there is a need to maintain a high SNR (good running durability) even after repeated running.

With regard to the above running durability, it has been proposed that the sliding properties between the surface of the magnetic layer and the head during running be stabilized and running durability be increased by incorporating lubricant into the magnetic layer and/or nonmagnetic layer. By contrast, Japanese Unexamined Patent Publication (KOKAI) No. 2009-283082, which is expressly incorporated herein by reference in its entirety, proposes incorporating lubricant into a backcoat layer positioned on the opposite side of the nonmagnetic support from the magnetic layer.

### SUMMARY OF THE INVENTION

By incorporating lubricant in the backcoat layer as proposed in Japanese Unexamined Patent Publication (KOKAI) No. 2009-283082, it is conceivably possible to supply lubricant to the surface of the magnetic layer from the backcoat layer by bringing the backcoat layer into contact with the surface of the magnetic layer when the tape is wound on a reel in a magnetic tape cartridge.

However, research conducted by the present inventors has revealed that when lubricant is simply incorporated into the backcoat layer, there may be cases where the SNR drops after repeated running, that is, there may be cases where the running durability is not improved.

An aspect of the present invention provides for a magnetic tape affording good running durability.

The present inventors conducted extensive research. As a result, they discovered the following magnetic tape:

A magnetic tape, comprising, on one surface of a nonmagnetic support, a nonmagnetic layer comprising nonmagnetic powder, lubricant, and binder;

comprising, on a surface of the nonmagnetic layer, a magnetic layer comprising magnetic powder, lubricant, and binder; and

comprising, on the opposite surface of the nonmagnetic support from the surface on which the nonmagnetic layer and magnetic layer are present, a backcoat layer comprising nonmagnetic powder, lubricant, and binder, wherein

the contact angle for water of a surface of the magnetic layer ranges from 95° to 100°, and

the contact angle for water of a surface of the backcoat layer ranges from 95° to 100°.

An aspect of the present invention was devised on that basis.

The contact angle for water will be referred to below as the water contact angle. The water contact angle is evaluated by the liquid drop method. Specifically, the water contact angle refers to the value of the arithmetic average of values obtained in six measurements conducted using water as the measurement liquid on a sample by the θ/2 method in a measurement environment of 25° C. and 25% relative humidity. The water contact angle of the surface of the magnetic layer and the water contact angle of the surface of the backcoat layer are measured using measurement samples obtained by cutting prescribed lengths off of the end of a roll of magnetic tape (magnetic tape roll) that has been wound into the form of a roll. An example of a specific form of the measurement method is described further below in Examples.

In one embodiment, the thickness of the nonmagnetic layer falls within a range of 0.05 to 0.50 μm.

In one embodiment, the magnetic layer contains:

nonmagnetic filler 1 having an average particle size φ1; and

nonmagnetic filler 2 having an average particle size φ2 (unit: nm) smaller than φ1 (unit: nm) and a Mohs hardness greater than the Mohs hardness of nonmagnetic filler 1;

where φ1 and φ2 satisfy equation 1:

20 nm≦φ1−φ2<50 nm equation 1.

In one embodiment, nonmagnetic filler 1 is selected from the group consisting of inorganic oxide particles and carbon black.

In one embodiment, nonmagnetic filler 1 contains colloidal particles.

In one embodiment, nonmagnetic filler 1 contains colloidal silica.

In one embodiment, nonmagnetic filler 2 is selected from the group consisting of alumina powder and silicon carbide powder.

In one embodiment, the nitrocellulose content of the backcoat layer falls within a range of 0.00 to 1.00 weight parts per 100.0 weight parts of the total quantity of the nonmagnetic powder.

In one embodiment, the nonmagnetic powder contained in the backcoat layer contains inorganic oxide powder and carbon black.

In one embodiment, the nonmagnetic powder contained in the backcoat layer comprises carbon black in a quantity falling within a range of 1.00 to 30.00 weight parts per 100.00 weight parts of the total quantity of the nonmagnetic powder.

In one embodiment, carbon black is contained in the nonmagnetic powder contained in the nonmagnetic layer.

In one embodiment, the lubricant contained in the magnetic layer, the lubricant contained in the nonmagnetic layer, and the lubricant contained in the backcoat layer each comprise one or more lubricants selected from the group consisting of fatty acids, fatty acid esters, and fatty acid amides.

In one embodiment, the lubricant contained in the magnetic layer and the lubricant contained in the backcoat layer each contain one or more fatty acids.

An aspect of the present invention can provide a magnetic tape affording good running durability.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

An aspect of the present invention relates to a magnetic tape, comprising, on one surface of a nonmagnetic support, a nonmagnetic layer comprising nonmagnetic powder, lubricant, and binder; comprising, on a surface of the nonmagnetic layer, a magnetic layer comprising magnetic powder, lubricant, and binder; and comprising, on the opposite surface of the nonmagnetic support from the surface on which the nonmagnetic layer and magnetic layer are present, a backcoat layer comprising nonmagnetic powder, lubricant, and binder, wherein the contact angle for water of a surface of the magnetic layer ranges from 95° to 100°, and the contact angle for water of a surface of the backcoat layer ranges from 95° to 100°.

The reasons the present inventors presume to be behind the good running durability afforded by the above magnetic tape are presented below, but are not intended to limit the present invention in any way.

The lubricant on the surface of the magnetic layer of a magnetic tape normally decreases as it adheres to the head during sliding against the head. However, the coefficient of friction can be inhibited from rising by making up the amount of the reduction caused by lubricant migrating from within the magnetic layer or from the nonmagnetic layer positioned beneath the magnetic layer. Further, the magnetic tape repeatedly runs between a pair of reels in the form of a feeding reel and a winding reel within the drive. When in a wound state, the surface of the magnetic layer comes into contact with the surface of the backcoat layer. Accordingly, incorporating lubricant into the backcoat layer as is suggested by Japanese Unexamined Patent Publication (KOKAI) No. 2009-283082 is thought to permit transfer of lubricant from the surface of the backcoat layer to the surface of the magnetic layer during the above contact.

According to research conducted by the present inventors, when lubricant was incorporated into just the backcoat layer as set forth above, a drop in the SNR was observed following repeated running. That is, it was difficult to enhance the running durability of a magnetic tape by simply incorporating lubricant into the backcoat layer.

Accordingly, the present inventors conducted further extensive research. As a result, they discovered that by keeping both the water contact angle of the surface of the magnetic layer and the water contact angle of the surface of the backcoat layer within a range of 95° to 100°, it was possible to obtain a magnetic tape that could exhibit good running durability in which the backcoat layer contained lubricant. The water contact angle that is measured for the surface of each layer is considered by the present inventors to be an indicator of the amount of lubricant present on that surface. The present inventors presume that keeping both the water contact angle of the surface of the magnetic layer and the water contact angle of the surface of the backcoat layer within a range of 95° to 100° means that there will be no great difference between the quantity of lubricant present on the surface of the magnetic layer and the quantity of lubricant present on the surface of the backcoat layer. The present inventors assume that this can promote transfer of lubricant from the surface of the backcoat layer to the surface of the magnetic layer or can contribute to a quantity of lubricant that is adequate to ensure running durability being present on the surface of the magnetic layer without impeding the transfer, thereby causing the magnetic tape to exhibit good running durability.

In contrast, when the quantity of lubricant that is present on the surface of the backcoat layer is excessively low relative to the lubricant that is present on the surface of the magnetic layer (that is, when the water contact angle of the backcoat layer is much lower than the water contact angle of the magnetic layer), lubricant may end up being supplied from the surface of the magnetic layer to the surface of the backcoat layer where the quantity of lubricant present is excessively low, either causing the quantity of lubricant on the surface of the magnetic layer to be inadequate, or causing an inadequate quantity of lubricant from being fed from the surface of the backcoat layer, on which the quantity of lubricant is relatively low relative to the surface of the magnetic layer, to the surface of the magnetic layer. The present inventors presume this to be why it is difficult to enhance the running durability by simply adding lubricant to the backcoat layer alone.

However, the above is merely a presumption by the present inventors, and is not intended to limit the present invention in any way.

The above magnetic tape will be described in greater detail below.

<1. Water Contact Angle of the Surface of the Magnetic Layer and the Water Contact Angle of the Surface of the Backcoat Layer>

The water contact angle of the surface of the magnetic layer in the above magnetic tape ranges from 95° to 100°, and the water contact angle of the surface of the backcoat layer ranges from 95° to 100°. A magnetic tape in which the water contact angle of the surface of the magnetic layer and the water contact angle of the surface of the backcoat layer are within the stated range can exhibit good running durability. Specifically, it can achieve a good SNR even with repeated running. The present inventors assume that this can be achieved by transfer of lubricant from the surface of the backcoat layer to the surface of the magnetic layer in a quantity adequate to ensure running durability during repeated running. The present inventors also presume that because of the above, shaving of the surface of the magnetic layer and of the head during repeated running causing spacing loss can be inhibited. The present inventors further assume that having the water contact angle of the surface of the magnetic layer and the water contact angle of the surface of the backcoat layer be less than or equal to 100° can contribute to inhibiting the drop in output that is caused by spacing loss due to lubricant that has adhered to the head from the surface of the magnetic layer; that, can contribute to inhibiting an excessive quantity of lubricant from adhering to the surface of the head.

From the perspective of more effectively inhibiting shaving of the surface of the magnetic layer and the head, it is desirable for at least either the water contact angle of the surface of the magnetic layer or the water contact angle of the surface of the backcoat layer to be greater than or equal to 96°, preferably greater than or equal to 97°. It is more preferable for both to be greater than or equal to 96°, and still more preferable for both to be greater than or equal to 97°

From the perspective of reducing spacing loss due to lubricant from the surface of the magnetic layer adhering to the head, it is desirable for either the water contact angle of the surface of the magnetic layer or the water contact angle of the surface of the backcoat layer to be less than or equal to 99°, preferably less than or equal to 98°. It is more preferable for both to be less than or equal to 99°, and still more preferably for both to be less than or equal to 98°.

The water contact angle of the surface of the magnetic layer and the water contact angle of the surface of the backcoat layer set forth above can be controlled by means of the types and quantities of lubricants incorporated into the various layers such as the magnetic layer, nonmagnetic layer, and backcoat layer, as well as by means of the types, quantities, and the like of the components present along with the lubricants in the various layers. By way of example, it is generally possible to raise the water contact angle of the surface of the magnetic layer by increasing the content of lubricant in the magnetic layer, nonmagnetic layer, and backcoat layer, and to lower it by reducing the content. For example, the water contact angle of the surface of the backcoat layer can be increased by increasing the content of lubricant in the backcoat layer, and reduced by decreasing the content. As a further example, it is possible to increase the water contact angle of the surface of the magnetic layer by decreasing the content of component(s) that tend to interact with lubricant, or by not incorporating such component(s), in the magnetic layer, nonmagnetic layer, and backcoat layer, and it is possible to decrease the water contact angle of the surface of the magnetic layer by increasing the content of such component(s). For example, it is possible to increase the water contact angle of the surface of the backcoat layer by reducing the content of component(s) that tend to interact with lubricant in the backcoat layer, and to decrease the water contact angle of the surface of the backcoat layer by increasing the content of such component(s). Accordingly, for example, the water contact angle of the surface of the magnetic layer and the water contact angle of the surface of the backcoat layer can be kept within the ranges set forth above by one, or a combination of any two or more, of the above means. This will be described in greater detail further below. So long as the water contact angle of the surface of the magnetic layer and the water contact angle of the surface of the backcoat layer both fall within a range of 95° to 100°, it does not matter which is larger or smaller.

The magnetic layer, nonmagnetic layer, and backcoat layer will each be described in greater detail below.

<2. Magnetic Layer>

### (2-1. Lubricant)

Examples of the lubricant that is contained in the magnetic layer are the various lubricants commonly employed in magnetic recording media, such as fatty acids, fatty acid esters, and fatty acid amides.

Examples of fatty acids are lauric acid, myristic acid, palmitic acid, steric acid, oleic acid, linoleic acid, linolenic acid, behenic acid, erucic acid, and elaidic acid. Stearic acid, myristic acid, and palmitic acid are desirable, and stearic acid is preferred. Fatty acids can also be incorporated into the magnetic layer in the form of salts such as metal salts.

Examples of fatty acid esters are esters of each of the above fatty acids, such as butyl myristate, butyl palmitate, butyl stearate, neopentyl glycol dioleate, sorbitan monostearate, sorbitan distearate, sorbitan tristearate, oleyl oleate, isocetyl stearate, isotridecyl stearate, octyl stearate, isooctyl stearate, amyl stearate, and butoxyethyl stearate.

Examples of fatty acid amides are amides of each of the above fatty acids, such as amide laurate, amide myristate, amide palmitate, and amide stearate.

The magnetic layer desirably contains at least a fatty acid that tends to readily migrate from the interior of the magnetic layer to the surface of the magnetic layer; preferably contains a fatty acid and one or more fatty acid derivative; still more preferably contains one or more selected from the group consisting of fatty acid esters and fatty acid amides, together with a fatty acid; and even more preferably, contains one or more fatty acids, one or more fatty acid esters, and one or more fatty acid amides.

When employing a fatty acid in combination with a fatty acid derivative (ester, amide, or the like), the moiety derived from a fatty acid of the fatty acid derivative desirably has a structure that is identical or similar to the fatty acid within which it is being used in combination. As an example, when employing a fatty acid in the form of stearic acid, it is desirable to employ a stearic ester and/or amide stearate.

The lubricant described in Japanese Unexamined Patent Publication (KOKAI) No. 2009-96798, paragraph 0111 can be employed. The content of the above publication is expressly incorporated herein by reference in its entirety

The content of lubricant in the magnetic layer is, for example, 2.00 to 20.00 weight parts, desirably 4.00 to 15.00 weight parts, and preferably, 6.00 to 10.00 weight parts, per 100.00 weight parts of ferromagnetic powder. When employing two or more different lubricants as lubricant, the content refers to the combined content thereof. Unless specifically stated otherwise in the present Specification, the same applies to the contents of other components.

(2-2. Binder)

The magnetic tape of an aspect of the present invention is a particulate magnetic recording medium, containing binder in the magnetic layer, as well as a nonmagnetic layer and a backcoat layer set forth further below. The binder contained in the magnetic layer can be in the form of polyurethane resin, polyester resin, polyamide resin, vinyl chloride resin, styrene, acrylonitrile, methyl methacrylate, and other copolymerized acrylic resins; nitrocellulose and other cellulose resins; epoxy resin; phenoxy resin; polyvinyl acetal, polyvinyl butyral, and other polyvinyl alkyrals; these resins can be employed singly or two or more resins can be mixed for use. Of these, the polyurethane resins, acrylic resins, and vinyl chloride resins are desirable. These resins can also be employed as binders in the nonmagnetic layer and backcoat layer, described further below. Reference can be made to Japanese Unexamined Patent Publication (KOKAI) No. 2010-24113, which is expressly incorporated herein by reference in its entirety, paragraphs 0028 to 0031, with regard to the binders.

Reference can be made to Japanese Unexamined Patent Publication (KOKAI) No. 2014-080563, paragraphs 0014 to 0027, and Examples given in the same; and the description of Examples in Japanese Unexamined Patent Publication (KOKAI) No. 2013-065381, paragraphs 0012 to 0016 and 0040 to 0136, with regard to binders. The binder content, for example, can fall within a range of 5.00 to 50.00 weight parts, desirably within a range of 10.00 to 30.00 weight parts, per 100.0 weight parts of ferromagnetic powder. The contents of the above publications are expressly incorporated herein by reference in their entirety.

It is also possible to employ a curing agent with the above resins. Polyisocyanates are suitable as curing agents. Reference can be made to Japanese Unexamined Patent Publication (KOKAI) No. 2011-216149, paragraphs 0124 and 0125, for details regarding polyisocyanates. The content of the above publication is expressly incorporated herein by reference in its entirety. The curing agent can be employed, for example, by adding a quantity of 0.00 to 80.00 weight parts, desirably 50.00 weight parts to 80.00 weight parts from the perspective of enhancing the coating strength, per 100.00 weight parts of binder to the composition (coating liquid) for forming the magnetic layer.

(2-3. Ferromagnetic Powder)

The ferromagnetic powder that is contained in the magnetic layer along with the lubricant and binder will be described next.

From the perspective of high density recording, the ferromagnetic powder desirably has an average particle size of less than or equal to 50 nm. From the perspective of stable magnetization, the average particle size of the ferromagnetic powder is desirably greater than or equal to 10 nm.

The average particle size of the ferromagnetic powder is a value that is measured by the following method with a transmission electron microscope.

Ferromagnetic powder is photographed at a magnification of 100,000-fold with a transmission electron microscope, and the photograph is printed on print paper at a total magnification of 500,000-fold to obtain a photograph of the particles constituting the ferromagnetic powder. A target particle is selected from the photograph of particles that has been obtained, the contour of the particle is traced with a digitizer, and the size of the (primary) particle is measured. The term “primary particle” refers to an unaggregated, independent particle.

The above measurement is conducted on 500 randomly extracted particles. The arithmetic average of the particle size of the 500 particles obtained in this manner is adopted as the average particle size of the ferromagnetic powder. A Model H-9000 transmission electron microscope made by Hitachi can be employed as the above transmission electron microscope, for example. The particle size can be measured with known image analysis software, such as KS-400 image analysis software from Carl Zeiss.

In the present invention, the average particle size of the powder is the average particle size as obtained by the above method. The average particle size indicated in Examples further below was obtained using a Model H-9000 transmission electron microscope made by Hitachi and KS-400 image analysis software made by Carl Zeiss.

The method described in paragraph 0015 of Japanese Unexamined Patent Publication (KOKAI) No. 2011-048878, which is expressly incorporated herein by reference in its entirety, for example, can be employed as the method of collecting sample powder such as ferromagnetic powder from a magnetic layer for particle size measurement.

In the present invention, the size of the particles constituting powder such as ferromagnetic powder (referred to as the “particle size”, hereinafter) is denoted as follows based on the shape of the particles observed in the above particle photograph:

(1) When acicular, spindle-shaped, or columnar (with the height being greater than the maximum diameter of the bottom surface) in shape, the particle size is denoted as the length of the major axis constituting the particle, that is, the major axis length.
(2) When plate like or columnar (with the thickness or height being smaller than the maximum diameter of the plate surface or bottom surface) in shape, the particle size is denoted as the maximum diameter of the plate surface or bottom surface.
(3) When spherical, polyhedral, of unspecific shape, or the like, and the major axis constituting the particle cannot be specified from the shape, the particle size is denoted as the diameter of an equivalent circle. The term “diameter of an equivalent circle” means that obtained by the circle projection method.

The “average acicular ratio” of a powder refers to the arithmetic average of values obtained for the above 500 particles by measuring the length of the minor axis, that is the minor axis length, of the particles measured above, and calculating the value of the (major axis length/minor axis length) of each particle. The term “minor axis length” refers to, in the case of the particle size definition of (1), the length of the minor axis constituting the particle; in the case of (2), the thickness or height, and in the case of (3), since the major axis and minor axis cannot be distinguished, (major axis length/minor axis length) is deemed to be 1 for the sake of convenience.

When the particle has a specific shape, such as in the particle size definition of (1) above, the average particle size is the average major axis length. In the case of (2), the average particle size is the average plate diameter, with the average plate ratio being the arithmetic average of (maximum diameter/thickness or height). For the definition of (3), the average particle size is the average diameter (also called the average particle diameter).

Hexagonal ferrite powder is a specific example of desirable ferromagnetic powder. From the perspectives of achieving higher density recording and magnetization stability, the average particle size (average plate diameter) of hexagonal ferrite powder desirably ranges from 10 nm to 50 nm, preferably 20 nm to 50 nm. Reference can be made to Japanese Unexamined Patent Publication (KOKAI) No. 2011-216149, paragraphs 0134 to 0136, for details on hexagonal ferrite powder.

Ferromagnetic metal powder is also a specific example of desirable ferromagnetic powder. From the perspectives of achieving higher density recording and magnetization stability, the average particle size (average major axis length) of ferromagnetic metal powder desirably ranges from 10 nm to 50 nm, preferably 20 nm to 50 nm. Reference can be made to Japanese Unexamined Patent Publication (KOKAI) No. 2011-216149, paragraphs 0137 to 0141, for details on ferromagnetic metal powder.

The content (fill rate) of ferromagnetic powder in the magnetic layer desirably falls within a range of 50 to 90 weight percent, preferably within a range of 60 to 90 weight percent. A high fill rate is desirable from the perspective of increasing the recording density.

(2-4. Additives)

The magnetic layer contains ferromagnetic powder, lubricant, and binder, and can contain one or more additives as necessary. Examples of additives are abrasives, dispersing agents, dispersion adjuvants, antifungal agents, antistatic agents, oxidation inhibitors, and carbon black. Additives can be suitably selected for use from among commercial products based on the physical properties that are desired.

Embodiments of additives will be described below. However, the present invention is not limited to the embodiments given below.

(2-4-1. Nonmagnetic Filler)

The magnetic layer desirably contains one, two, or more nonmagnetic fillers. Examples of nonmagnetic fillers are nonmagnetic fillers that are capable of functioning as abrasives and nonmagnetic fillers that can function as agents, protrusion-forming agents, that form protrusions suitably protruding from the surface of the magnetic layer. Protrusion-forming agents are components that can contribute to controlling the friction properties of the surface of the magnetic layer. At least one of the two types of the above nonmagnetic fillers is desirably incorporated, and both of the two types of the above nonmagnetic fillers are preferably incorporated, in the magnetic layer of the above magnetic tape.

In a magnetic layer containing abrasive and a protrusion-forming agent, the average particle size of the abrasive is desirably smaller and the Mohs hardness greater than those of the protrusion-forming agent. When a protrusion-forming agent is employed as nonmagnetic filler 1 and an abrasive as nonmagnetic filler 2, from the perspective of further enhancing running durability, the average particle size φ1 (unit: nm) of nonmagnetic filler 1 and the average particle size φ2 (unit: nm) of nonmagnetic filler 2 desirably satisfy the relation of equation 1. As set forth above, the Mohs hardness of nonmagnetic filler 2 is desirably greater than the Mohs hardness of nonmagnetic filler 1.

20 nm<(φ1−φ2<50 nm equation 1

From the perspective of more effectively controlling the occurrence of spacing loss due to head shavings, the difference (φ1-φ2) is desirably less than or equal to 50 nm. From this perspective, the difference (φ1-φ2) is preferably less than or equal to 40 nm, and more preferably, less than or equal to 35 nm. From the perspective of further effectively lowering the coefficient of friction, the difference (φ1-φ2) is desirably greater than or equal to 20 nm. From this perspective, the difference (φ1-φ2) is preferably greater than or equal to 25 nm.

The abrasive is a component that generally contributes to maintaining running durability by removing head deposits (being abrasive). From the perspective of being able to properly remove head deposits, an abrasive in the form of filler with a Mohs hardness of greater than or equal to 7 is desirable. The Mohs hardness is a widely known indicator of the hardness of a substance. The Mohs hardness specifies the hardness of a substance on a scale of 1 to 10. The maximum Mohs hardness is that of diamond, which has a Mohs hardness of 10. Nonmagnetic filler 2 desirably has a Mohs hardness of greater than or equal to 8. Nonmagnetic filler 2 desirably has a Mohs hardness of less than or equal to 9. Examples of nonmagnetic filler 2 are substances that are commonly employed as abrasives in magnetic layers in the form of various powders such as alumina (Al₂O₃), silicon carbide, boron carbide (B₄C), SiO₂, TiC, chromium oxide (Cr₂O₃), cerium oxide, zirconium oxide (ZrO₂), iron oxide, and diamond. Among these, alumina powder and silicon carbide powder are desirable. Nonmagnetic filler 2 can be of any shape, such as acicular, spherical, or cubic. A shape having an angular portion is desirable for heightened abrasiveness.

The dispersing agent described in Japanese Unexamined Patent Publication (KOKAI) No. 2013-131285, paragraphs 0012 to 0022, is an example of a dispersing agent for enhancing dispersion of abrasives as an additive that can be used in a magnetic layer containing an abrasive. The content of the above publication is expressly incorporated herein by reference in its entirety.

Nonmagnetic fillers that are commonly used as protrusion-forming agents can be employed as nonmagnetic filler 1. They can be organic or inorganic substances. In one embodiment, from the perspective of achieving uniform frictional properties, the particle size distribution of the nonmagnetic filler is desirably a monodispersion exhibiting a single peak, and not a multidispersion having multiple peaks in the distribution. From the perspective of the availability of monodisperse particles, the nonmagnetic filler is desirably powder of an inorganic substance. Examples of powders of inorganic substances are various powders of metal oxides, metal carbonates, metal sulfates, metal nitrides, metal carbides, and metal sulfides. The powder of an inorganic oxide is desirable. Nonmetal filler 1 is preferably colloidal particles, preferably colloidal particles of an inorganic oxide. From the perspective of the availability of monodisperse particles, an inorganic oxide in the form of silicon dioxide (silica) is desirable, and colloidal silica (silica colloid particles) is preferred. The average particle size of the colloidal particles is a value that is calculated by the method described as a measurement method of the average particle diameter in Japanese Unexamined Patent Publication (KOKAI) No. 2011-048878, paragraph 0015. The content of the above publication is expressly incorporated herein by reference in its entirety. In another embodiment, nonmagnetic filler 1 is desirably carbon black.

The average particle size φ1 of nonmagnetic filler 1 (protrusion-forming agent) is, for example, 30 to 300 nm, desirably 50 to 200 nm. The average particle size of nonmagnetic filler φ2 (abrasive) is, for example, 30 to 300 nm, desirably 50 to 200 nm. The difference (φ1-φ2) between average particle sizes φ1 and φ2 is as set forth above.

From the perspective of properly developing the individual functions of the protrusion-enhancing agent and abrasive, the content of nonmagnetic filler 1 (protrusion-forming agent) in the magnetic layer is desirably 1.00 to 4.00 weight parts, preferably 1.50 to 3.50 weight parts, per 100.00 weight parts of ferromagnetic powder. Additionally, the content of nonmagnetic filler 2 (abrasive) in the magnetic layer is desirably 1.00 to 20.00 weight parts, preferably 3.00 to 15.00 weight parts, and more preferably, 4.00 to 10.00 weight parts, per 100.00 weight parts of ferromagnetic powder.

(2-4-2. Dispersing Agent)

The greater the surface smoothness of the magnetic layer, the greater the advantage in achieving higher density recording. One way to increase the surface smoothness of the magnetic layer is to use component(s) (dispersing agent(s)) that contribute to enhancing dispersion of the ferromagnetic powder. The magnetic layer of the above magnetic tape can contain one, two, or more dispersing agents; the incorporation of a dispersing agent is desirable. Known dispersing agents can be employed without limitation.

An example of a desirable dispersing agent in the form of a polyalkyleneimine polymer will be described. However, the present invention is not limited to containing the following polyalkyleneimine polymer in the magnetic layer.

(2-4-3. Polyalkyleneimine Polymer)

(2-4-3-a. Polyalkyleneimine Chain)

The term “polyalkyleneimine polymer” refers to a polymer containing one or more polyalkyleneimine chains. In the present invention, the term “polymer” is a polymer comprised of multiple identical or different repeating units, and is used with a meaning that includes both homopolymers and copolymers. The term “polyalkyleneimine chain” refers to a polymerization structure comprising two or more identical or different alkyleneimine chains. Examples of the alkyleneimine chains that are contained are the alkyleneimine chain denoted by formula A below and the alkyleneimine chain denoted by formula B below. Among the alkyleneimine chains denoted by the formulas given below, the alkyleneimine chain denoted by formula A can contain a bond position with another polymer chain. The alkyleneimine chain denoted by formula B can be bonded by means of a salt crosslinking group (described in greater detail further below) to another polymer chain. The polyalkyleneimine chain can have only a linear structure, or can have a branched tertiary amine structure. Examples comprising branched structures are ones where the alkyleneimine chain is bonded to an adjacent alkyleneimine chain at *¹ in formula A below and where it is bonded to the adjacent alkyleneimine chain at *² in formula B below.

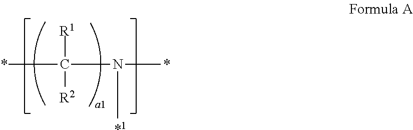

In formula A, each of R¹ and R² independently denotes a hydrogen atom or an alkyl group; a1 denotes an integer of equal to or greater than 2; and *¹ denotes the site of a bond with an adjacent another polymer chain (such as a polyester chain, an adjacent alkyleneimine chain set forth below), or a hydrogen atom or a substituent.

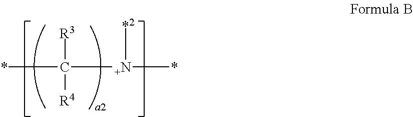

In formula B, each of R³ and R⁴ independently denotes a hydrogen atom or an alkyl group, and a2 denotes an integer of equal to or greater than 2. The alkyleneimine chain denoted by formula B bonds to another polymer chain having an anionic group by N⁺ in formula B and the anionic group contained in another polymer chain forming a salt crosslinking group.

The * in formulas A and B, and the *² in formula B, each independently denotes the position of a bond with an adjacent alkyleneimine chain, a hydrogen atom or a substituent.

Formulas A and B will be described in greater detail below. In the present invention, unless specifically stated otherwise, the groups that are described can be substituted or unsubstituted. When a given group comprises substituent(s), examples of the substituent are alkyl groups (such as alkyl groups having 1 to 6 carbon atoms), hydroxyl groups, alkoxy groups (such as alkoxy groups having 1 to 6 carbon atoms), halogen atoms (such as fluorine atoms, chlorine atoms, and bromine atoms), cyano groups, amino groups, nitro groups, acyl groups, and carboxyl groups. For a group having a substituent, the “number of carbon atoms” means the number of carbon atoms of the portion not comprising the substituent.

Each of R¹ and R² in formula A, and each of R³ and R⁴ in formula B, independently denotes a hydrogen atom or an alkyl group. Examples of the alkyl groups are alkyl groups having 1 to 6 carbon atoms, desirably alkyl groups having 1 to 3 carbon atoms, preferably methyl or ethyl groups, and more preferably, methyl groups. Combinations of R¹ and R² in formula A include an embodiment where one denotes a hydrogen atom and the other denotes an alkyl group, an embodiment where both denote alkyl groups (identical or different alkyl groups), and desirably, an embodiment where both denote hydrogen atoms. The above matters are also applied to R³ and R⁴ in formula B.

The structure with the fewest carbon atoms constituting the ring in an alkyleneimine is ethyleneimine. The number of carbon atoms on the main chain of the alkyleneimine chain (ethyleneimine chain) obtained by opening the ring of ethyleneimine is 2. Accordingly, the lower limit of a1 in formula A and of a2 in formula B is 2. That is, each of a1 in formula A and a2 in formula B independently denotes an integer of equal to or greater than 2. From the perspective of adsorption to the surface of particles of ferromagnetic powder, each of a1 in formula A and a2 in formula B is independently desirably equal to or less than 10, preferably equal to or less than 6, more preferably equal to or less than 4, still more preferably 2 or 3, and yet still more preferably, 2.

The bond between the alkyleneimine chain denoted by formula A or the alkyleneimine chain denoted by formula B and another polymer chain will be described further below.

Each of the alkyleneimine chains set forth above bonds to an adjacent alkyleneimine chain, a hydrogen atom, or a substituent at the positions denoted by * in the various formulas above. An example of a substituent is a monovalent substituent such as an alkyl group (such as an alkyl group with 1 to 6 carbon atoms), but this is not a limitation. Another polymer chain (such as a polyester chain set forth below) can also be bonded as a substituent.

With regard to the polyalkyleneimine polymer, the present inventors presume that the polyalkyleneimine chain can function as an adsorbing moiety that can adsorb to the surface of the particles of ferromagnetic powder. From the perspective of adsorption to the surface of the particles of ferromagnetic powder, the number average molecular weight of the polyalkyleneimine chain is desirably equal to or higher than 300, and preferably equal to or higher than 500. From the same perspective, it is desirably equal to or lower than 3,000, and preferably equal to or lower than 2,000.

In the present invention, the number average molecular weight of the polyalkyleneimine chain contained in the polyalkyleneimine polymer refers to a value, obtained by gel permeation chromatography (GPC) using standard polystyrene conversion, for the polyalkyleneimine obtained by hydrolyzing the polyalkyleneimine polymer. The value thus obtained is the same as or similar to the value obtained by gel permeation chromatography (GPC) using standard polystyrene conversion for the polyalkyleneimine used to synthesize the polyalkyleneimine polymer. Accordingly, the number average molecular weight obtained for the polyalkyleneimine used to synthesize the polyalkyleneimine polymer can be adopted as the number average molecular weight of the polyalkyleneimine chain contained in the polyalkyleneimine polymer. Reference can be made to Examples set forth further below for the conditions for measuring the number average molecular weight of the polyalkyleneimine chain. Polyalkyleneimine is a polymer that can be obtained by ring-opening polymerization of alkyleneimine.

Further, hydrolysis of the polyalkyleneimine polymer can be conducted by any of the various methods commonly employed as ester hydrolysis methods. For details regarding such methods, for example, reference can be to the description of hydrolysis methods given in “Experimental Chemistry Lecture 14 Synthesis of Organic Compounds II-Alcohols.Amines (5th Ed.),” (compiled by the Chemical Society of Japan, Maruzen Publishing, released August 2005), pp. 95 to 98; and to the description of hydrolysis methods given in “Experimental Chemistry Lecture 16 Synthesis of Organic Compounds IV-Carboxylic Acids.Amino Acids.Peptides (5th Ed.),” (compiled by the Chemical Society of Japan, Maruzen Publishing, released March 2005), pp. 10 to 15, which are expressly incorporated herein by reference in their entirety.

Polyalkyleneimine can be separated from the hydrolysis product thus obtained by known separation means such as liquid chromatography, and the number average molecular weight thereof can be obtained.

From the perspective of enhancing dispersion of ferromagnetic powder, the proportion accounted for by polyalkyleneimine chains in the polyalkyleneimine polymer (also referred to as the “polyalkyleneimine chain ratio”, hereinafter) is desirably less than 5.0 weight percent, preferably less than or equal to 4.9 weight percent, more preferably less than or equal to 4.8 weight percent, still more preferably less than or equal to 4.5 weight percent, yet more preferably less than or equal to 4.0 weight percent, and even more preferably, less than or equal to 3.0 weight percent. From the same perspective, the polyalkyleneimine chain ratio is desirably greater than or equal to 0.2 weight percent, preferably greater than or equal to 0.3 weight percent, and more preferably, greater than or equal to 0.5 weight %.

The above proportion accounted for by polyalkyleneimine chains can be controlled, for example, by means of the mixing ratio of polyalkyleneimine and polyester employed during synthesis.

The proportion in the polyalkyleneimine polymer accounted for by the polyalkyleneimine chain can be calculated from the results of analysis by nuclear magnetic resonance (NMR)—more specifically, ¹H-NMR and ¹³C-NMR— and by elemental analysis by known methods. Since the value thus calculated is identical to or similar to the theoretical value obtained from the compounding ratio of the synthesis starting materials of the polyalkyleneimine polymer, the theoretical value obtained from the compounding ratio can be adopted as the proportion in the polyalkyleneimine polymer accounted for by the polyalkyleneimine chain (polyalkyleneimine chain ratio).

(2-4-3-b. Polyester Chain)

In addition to the polyalkyleneimine chain set forth above, the polyalkyleneimine polymer desirably comprises another polymer chain(s). Another polymer chain(s) is thought to suppress aggregation between particles of ferromagnetic powder as a steric repulsion chain in the composition for forming a magnetic layer. From this perspective, a desirable example of another polymer chain is a polyester chain. In one embodiment, the alkyleneimine chain denoted by formula A and a polyester chain can form —N—(C═O)— by bonding of the nitrogen atom N in formula A to a carbonyl group —(C═O)— at *¹ in formula A. In another embodiment, the alkyleneimine chain denoted by formula B and a polyester chain can form a salt crosslinking group by means of the nitrogen cation N⁺ in formula B and the anionic group present in a polyester chain. An example of a salt crosslinking group is one formed from the oxygen anion O⁻ contained in a polyester chain and the N⁺ contained in formula B. However, this is not intended as a limitation.

The polyester chain denoted by formula 1 below is an example of a polyester chain bonding to the nitrogen atom N contained in formula A by means of a carbonyl bond —(C═O)— to the alkyleneimine chain denoted by formula A. The polyester chain denoted by formula 1 below can bond to the alkyleneimine chain denoted by formula A at the bond position denoted by *¹ by the formation of —N—(C═O)— by the nitrogen atom contained in the alkyleneimine chain and the carbonyl group —(C═O)— contained in the polyester chain.

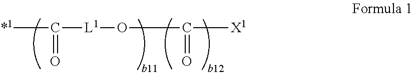

The polyester chain denoted by formula 2 below is an example of a polyester chain that can bond to the alkyleneimine chain denoted by formula B by means of the N⁺ in formula B and an anionic group contained in the polyester chain forming a salt crosslinking group. In the polyester group denoted by formula 2 below, the oxygen anion O⁻ and the N⁺ in formula B can form a salt crosslinking group.

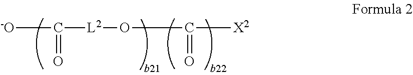

Each of L¹ in formula 1 and L² in formula 2 independently denotes a divalent linking group. A desirable example of a divalent linking group is an alkylene group having 3 to 30 carbon atoms. As set forth above, the number of carbon atoms in an alkylene group refers to the portion (main chain portion) excluding the substituent when the alkylene group comprises a substituent.

Each of b11 in formula 1 and b21 in formula 2 independently denotes an integer of equal to or greater than 2; for example, an integer of equal to or less than 200. The number of repeating lactone units given in Examples further below corresponds to b11 in formula 1 or b21 in formula 2.

Each of b12 in formula 1 and b22 in formula 2 independently denotes 0 or 1.

Each of X¹ in formula 1 and X² in formula 2 independently denotes a hydrogen atom or a monovalent substituent. Examples of monovalent substituents are monovalent substituents selected from the group consisting of alkyl groups, haloalkyl groups (such as fluoroalkyl groups), alkoxy groups, polyalkyleneoxyalkyl groups, and aryl groups.

The alkyl group may be substituted or unsubstituted. An alkyl group substituted with at least one hydroxyl group (a hydroxyalkyl group) and an alkyl group substituted with at least one halogen atom are desirable as a substituted alkyl group. An alkyl group in which all the hydrogen atoms bonded to carbon atoms have been substituted with halogen atoms (a haloalkyl group) is also desirable. Examples of halogen atoms include fluorine, chlorine and bromine atoms. An alkyl group having 1 to 30 carbon atoms is preferred, and an alkyl group having 1 to 10 carbon atoms is of greater preference. The alkyl group can be linear, have a branched chain, or be cyclic. The same applies to a haloalkyl group.

Specific examples of substituted and unsubstituted alkyl groups and haloalkyl groups are: a methyl group, ethyl group, propyl group, butyl group, pentyl group, hexyl group, heptyl group, octyl group, nonyl group, decyl group, undecyl group, dodecyl group, tridecyl group, pentadecyl group, hexadecyl group, heptadecyl group, octadecyl group, eicosyl group, isopropyl group, isobutyl group, isopentyl group, 2-ethylhexyl group, tert-octyl group, 2-hexyldecyl group, cyclohexyl group, cyclopentyl group, cyclohexylmethyl group, octylcyclohexyl group, 2-norbornyl group, 2,2,4-trimethylpentyl group, acetylmethyl group, acetylethyl group, hydroxymethyl group, hydroxyethyl group, hydroxylpropyl group, hydroxybutyl group, hydroxypentyl group, hydroxyhexyl group, hydroxyheptyl group, hydroxyoctyl group, hydroxynonyl group, hydroxydecyl group, chloromethyl group, dichloromethyl group, trichloromethyl group, bromomethyl group, 1,1,1,3,3,3-hexafluoroisopropyl group, heptafluoropropyl group, pentadecafluoroheptyl group, nonadecafluorononyl group, hydroxyundecyl group, hydroxydodecyl group, hydroxypentadecyl group, hydroxyheptadecyl group, and hydroxyoctadecyl group.

Examples of alkoxy groups are a methoxy group, ethoxy group, propyloxy group, hexyloxy group, methoxyethoxy group, methoxyethoxyethoxy group, and methoxyethoxyethoxymethyl group.

Polyalkyleneoxyalkyl groups are monovalent substituents denoted by R¹⁰(OR¹¹)n(O)m-. R¹⁰ denotes an alkyl group, R¹¹ denotes an alkylene group, n denotes an integer of equal to or greater than 2, and m denotes 0 or 1.

The alkyl group denoted by R¹⁰ is as described for the alkyl groups denoted by X¹ and X². The details of the alkylene group denoted by R¹¹ are as follows. The above description of the alkyl groups denoted by X¹ and X² can be applied to these alkylene groups by reading alkylenes with one fewer hydrogen atom for the former (for example, by reading “methylene group” for “methyl group”). n denotes an integer of equal to or greater than 2; for example, an integer of equal to or less than 10, desirably equal to or less than 5.

The aryl group can be substituted and can be a condensed ring. It is preferably an aryl group with 6 to 24 carbon atoms, such as a phenyl group, a 4-methylphenyl group, 4-phenylbenzoic acid, a 3-cyanophenyl group, a 2-chlorophenyl group, or a 2-naphthyl group.

The polyester chains denoted by formulas 1 and 2 above can be structures derived from polyesters obtained by known polyester synthesis methods. Lactone ring-opening polymerization is an example of a polyester synthesis method. Examples of lactones are ε-captolactone, δ-caprolactone, β-propiolactone, γ-butyrolactone, δ-valerolactone, γ-valerolactone, enantolactone, β-butyrolactone, γ-hexanolactone, γ-octanolactone, δ-hexanolactone, δ-octanolactone, δ-dodecanolactone, α-methyl-γ-butyrolactone, and lactide. The lactide can be of either the L or D form. In polyester synthesis, it is possible to use one type of lactone, or two types or more of differing structure. ε-lactone, lactides, and δ-valerolactone are desirable as lactones from the perspectives of reactivity and availability. However, there is no limitation thereto. Any lactone yielding polyester by means of ring-opening polymerization will do.

Carboxylic acid, alcohols, and the like can be employed as nucleophilic reagents in lactone ring-opening polymerization. Carboxylic acid is desirable. One type of carboxylic acid or a mixture of two or more types can be employed.

Carboxylic acid can be denoted as R¹²(C═O)OH. The moiety R¹²(C═O)— can be present as the moiety X¹—(C═O)— in the polyester chain denoted by formula 1. The same applies to the moiety X²—(C═O)— on the polyester chain denoted by formula 2.

R¹² can be acyclic in structure (linear or branched in structure), or can be cyclic in structure. The details of R¹² are as set forth for X¹ in formula 1 and X² in formula 2 above.

Examples of carboxylic acids are acetic acid, propionic acid, butyric acid, valeric acid, n-hexanoic acid, n-octanoic acid, n-decanoic acid, n-dodecanoic acid, palmitic acid, 2-ethylhexanoic acid, cyclohexanoic acid, stearic acid, glycolic acid, lactic acid, 3-hydroxypropionic acid, 4-hydroxydodecanoic acid, 5-hydroxydodecanoic acid, cyclohexylacetic acid, adamantanecarboxylic acid, adamantaneacetic acid, ricinoleic acid, 12-hydroxydodecanoic acid, 12-hydroxystearic acid, 2,2-bis(hydroxymethyl)butyric acid, [2-(2-methoxyethoxy)ethoxy)]acetic acid, monochloroacetic acid, dichloroacetic acid, bromoacetic acid, nonafluorovaleric acid, heptadecafluorononanoic acid, 3,5,5-trimethylhexanoic acid, acetyl acetic acid, 4-oxovaleric acid, benzoic acid, 4-phenylbenzoic acid, and 2-naphthoic acid. Among these, carboxylic acids with 1 to 20 total carbon atoms per molecule (including the number of carbon atoms of the substituents when present) are desirable. Carboxylic acids in which R¹² is a polyalkyleneoxyalkyl group (polyalkyleneoxyalkylcarboxylic acids), carboxylic acids in which R¹² is a haloalkyl group (haloalkylcarboxylic acids), linear aliphatic carboxylic acids having 6 to 20 carbon atoms, and carboxylic acids comprising at least one hydroxyl group with 1 to 20 carbon atoms are preferred.

However, the above polyester chain is not limited to a structure derived from polyester obtained by lactone ring-opening polymerization. It can have a structure derived from polyester obtained by a known polyester synthesis method such as polycondensation of a polyvalent carboxylic acid and polyhydric alcohol or polycondensation of a hydroxycarboxylic acid.

From the perspective of enhancing dispersion of ferromagnetic powder, the number average molecular weight of the polyester chain is desirably greater than or equal to 200, preferably greater than or equal to 400, and more preferably, greater than or equal to 500. From the same perspective, the number average molecular weight of the polyester chain is desirably less than or equal to 100,000, preferably less than or equal to 50,000. The term “number average molecular weight of the polyester chain” refers to a value that is obtained by hydrolyzing the polyalkyleneimine polymer to obtain a polyester, using gel permeation chromatography (GPC), and converting to a standard polystyrene conversion. The value that is thus obtained is identical to or similar to the value that is obtained by subjecting the polyester that is used to synthesize the polyalkyleneimine polymer to gel permeation chromatography (GPC) and converting to a standard polystyrene conversion. Accordingly, the number average molecular weight calculated for the polyester employed to synthesize the polyalkyleneimine polymer can be adopted as the number average molecular weight of the polyester chain contained in the polyalkyleneimine polymer. Reference can be made to the conditions used to measure the number average molecular weight of the polyester in Examples given further below for the conditions used to measure the number average molecular weight of the polyester chain.

(2-4-3-c. Weight Average Molecular Weight of the Polyalkyleneimine Polymer)

The molecular weight of the polyalkyleneimine polymer is, for example, greater than or equal to 1,000, and also by way of example, less than or equal to 80,000, as a weight average molecular weight. The weight average molecular weight of the polyalkyleneimine polymer is desirably greater than or equal to 1,500, preferably greater than or equal to 2,000, and more preferably, greater than or equal to 3,000. In one embodiment, the weight average molecular weight of the polyalkyleneimine polymer is desirably less than or equal to 60,000, preferably less than or equal to 40,000, more preferably less than or equal to 35,000, and still more preferably, less than or equal to 34,000.

In the present invention, the term “weight average molecular weight of the polyalkyleneimine polymer” refers to a value that is obtained by gel permeation chromatography (GPC) and converted to the standard styrene conversion. Reference can be made to Examples further below for measurement conditions.

(2-4-3-d. Synthesis Methods)

The synthesis method of the polyalkyleneimine polymer is not specifically limited. An example of a desirable embodiment of synthesis method is the method of reacting polyalkyleneimine (referred to as “component A-1”, hereinafter) with polyester (referred to as “component A-2”, hereinafter).

Component A-1 desirably has a number average molecular weight set forth above for the polyalkyleneimine chain. The details of the measurement method, desirable range, and the like of the number average molecular weight of component A-1 are the same as those set forth for the polyalkyleneimine chain above.

Polyalkyleneimine is a polymer that can be obtained by alkyleneimine ring-opening polymerization, as set forth above. The details of the structure of polyalkyleneimine are as set forth for the polyalkyleneimine chain above.

The same one, two, or more types of different alkyleneimines can be employed as the alkyleneimines yielding polyalkyleneimine by ring-opening polymerization. Details regarding the number of carbon atoms of the alkyleneimine are as set forth above for a1, a2, and a3 in formulas A, B, and C. Alkyleneimines with 2 to 4 carbon atoms are desirably employed. Alkyleneimines with 2 or 3 carbon atoms are preferred. An alkyleneimine with two carbon atoms, that is, ethyleneimine, is of greater preference. The number of carbon atoms in an alkyleneimine refers to the number of carbon atoms in the ring structure.

The polyalkyleneimine employed as component A-1 can be synthesized by known methods or obtained as a commercial product.

Component A-2 is polyester. A polyester chain can be imparted to the polyalkyleneimine polymer by means of component A-2. Details regarding the measurement method, desirable range, and the like of the number average molecular weight of component A-2 are as set forth above for the polyester chain.

Component A-2 can react with the polyalkyleneimine by having one or more functional groups capable of reacting with the polyalkyleneimine. As set forth above, in the polyalkyleneimine polymer thus formed, the polyester chain desirably bonds with the alkyleneimine chain constituting the polyalkyleneimine chain by means of —N—(C═O)— or a salt crosslinking group. To impart such a bond, the functional group of the polyester is desirably in the form of a monovalent acidic group. In this context, the term “acidic group” refers to a group that is capable of dissociating into an anion by releasing H⁺ in water in a solvent containing water (aqueous solvent). Such groups can form bonds with polyalkyleneimine chains or form salt crosslinking groups. Specific examples are a carboxyl group, sulfonic acid group, phosphoric acid group, and salts thereof. A carboxyl group and carboxyl salt group are desirable. In this context, the form of the salt of a carboxyl group (—COOH) means a carboxyl salt group in which the M in —COOM denotes a cation such as an alkali metal ion. The same applies to the forms of salts of other acidic groups. From the perspective of introducing a polyester chain capable of effectively functioning as a steric repulsion chain, the number of the functional groups contained in component A-2 is desirably 1. From the same perspective, the functional group is desirably incorporated as a terminal functional group in component A-2.

The acidic group has been specified above with regard to water or an aqueous solvent. However, the polyalkyleneimine polymer is not limited to those that can be employed in a water-based (in this context, the term “based” is used to mean “containing”) solvent. It can desirably be employed in non-water-based solvents. The solvent contained in the coating composition for various layers such as a magnetic layer, a nonmagnetic layer and a backcoat layer described further below is not limited to water-based solvents. It can be a non-water-based solvent, and is desirably a non-water-based solvent.

Details of the structure of the polyester are as set forth for the polyester chain above. The above-described polyester can be synthesized by known methods or can be obtained as a commercial product. For example, polyester having a terminal functional group in the form of a carboxyl group can be obtained by the method of conducting lactone ring-opening polymerization in the presence of a nucleophilic reagent such as carboxylic acid. With regard to the polyester synthesis conditions, known techniques can be applied without limitation. The polyester having a carboxyl group as a terminal functional group can be bonded with the alkyleneimine chain denoted by formula A by means of —N—(C═O)—. It can also be bonded with the alkyleneimine denoted by formula B by means of the above-described salt crosslinking group. Details such as specific examples of carboxylic acids and the like are as set forth above.

The reaction of above-described components A-1 and A-2 can be conducted by known polymerization methods such as solution polymerization and the like. For example, it can be conducted by stirring and mixing components A-1 and A-2, optionally in the presence of an organic solvent. The reaction can progress without a solvent. For example, a reaction solution containing components A-1 and A-2 can be heated (to a heating temperature of 50° C. to 200° C., for example) while being stirred in air or in a nitrogen atmosphere, or heated (to a heating temperature of 40° C. to 150° C., for example) while adding a catalyst such as an organic tin compound such as monobutyltin oxide, an ammonium salt such as trimethylammonium bromide, a tertiary amine such as benzyldimethylamine, or a quaternary ammonium salt, to conduct the reaction. Examples of organic solvents are ethyl acetate, chloroform, tetrahydrofuran, methyl ethyl ketone, acetone, acetonitrile, and toluene.

(2-4-4-e. Other Polymer Chain)

The polyalkyleneimine polymer can comprise one or more polymer chains other than a polyester chain, and can comprise both a polyester chain and a polymer chain other than a polyester chain. The same method as that set forth above for introducing a polyester chain can be used to introduce such a polymer chain into a polyalkyleneimine polymer.

(2-4-4-f. Content of Polyalkyleneimine Polymer)

When the magnetic layer contains the above-described polyalkyleneimine polymer, from the perspective of enhancing dispersion of ferromagnetic powder, it is desirable for the content of the polyalkyleneimine polymer in the magnetic layer to be greater than or equal to 0.50 weight part, preferably greater than or equal to 1.00 weight part, per 100.00 weight parts of ferromagnetic powder. From the perspective of high density recording, it is desirable for the content of other components to be relatively low to increase the fill rate of ferromagnetic powder. From this perspective, the content of polyalkyleneimine polymer in the magnetic layer is desirably less than or equal to 50.00 weight parts, preferably less than or equal to 40.00 weight parts, per 100.00 weight parts of ferromagnetic powder. The dispersion of ferromagnetic powder of suitably small particle size for high density recording, such as an average particle size of less than or equal to 50 nm, can be improved by the above polyalkyleneimine polymer.

The magnetic layer described above is provided over a nonmagnetic layer on a nonmagnetic support. Details regarding the nonmagnetic layer and nonmagnetic support will be given further below.

<3. Nonmagnetic Layer>

Details of the nonmagnetic layer will be described next. In the magnetic tape of an aspect of the present invention, a nonmagnetic layer containing nonmagnetic powder and binder is present between the nonmagnetic support and the magnetic layer. Either inorganic substances or organic substances can be employed as the nonmagnetic powder in the nonmagnetic layer. Carbon black can also be employed. Examples of inorganic substances are metals, metal oxides, metal carbonates, metal sulfates, metal nitrides, metal carbides, and metal sulfides. These nonmagnetic powders are available as commercial products and can be manufactured by known methods. Reference can be made to Japanese Unexamined Patent Publication (KOKAI) No. 2011-216149, paragraphs 0146 to 0150 and Japanese Unexamined Patent Publication (KOKAI) No. 2013-049832, paragraphs 00019 to 0020, for details in that regard. The contents of the above publications are expressly incorporated herein by reference in their entirety.

The content of nonmagnetic powder in the nonmagnetic layer desirably falls within a range of 50 to 90 weight percent, preferably within a range of 60 to 90 weight percent.

The binders, lubricants, dispersing agents, other additives, solvents, dispersion methods, and the like of the magnetic layer can be applied to the nonmagnetic layer. Specifically, techniques known with regard to the magnetic layer regarding the quantity and type of binder and the quantities and types of additives and dispersing agents can be applied. It is also possible to add carbon black and organic powders to the nonmagnetic layer. Reference can be made to Japanese Unexamined Patent Publication (KOKAI) No. 2010-24113, paragraphs 0040 to 0042, in that regard. The content of the above publication is expressly incorporated herein by reference in its entirety.

The nonmagnetic layer also desirably contains lubricant. That is because the nonmagnetic layer can function as a tank supplying lubricant to the magnetic layer. Reference can be made to the description given above with regard to the magnetic layer for lubricant that can be added to the nonmagnetic layer. The content of lubricant in the nonmagnetic layer is, for example, 0.50 to 10.00 weight parts, desirably 1.50 to 6.00 weight parts, and preferably, 2.50 to 4.00 weight parts, per 100.00 weight parts of nonmagnetic powder. Carbon black has less of a tendency to adsorb lubricant than various nonmagnetic powders that can be employed as the nonmagnetic powder in the nonmagnetic layer. A tendency of nonmagnetic powder not to adsorb lubricant relates to increasing the quantity of lubricant migrating from the nonmagnetic layer to the magnetic layer and then on to the surface of the magnetic layer. Accordingly, one desirable way to control the water contact angle of the surface of the magnetic layer is to employ carbon black as part or all of the nonmagnetic powder in the nonmagnetic layer.

Additives that are capable of functioning as dispersing agents to enhance the dispersion of nonmagnetic powder are examples of additives in the nonmagnetic layer. Examples of such additives are organic tertiary amines. Organic tertiary amines are desirably added to a nonmagnetic layer containing carbon black as nonmagnetic powder. Their addition can enhance dispersion of the carbon black. Reference can be made to Japanese Unexamined Patent Publication (KOKAI) No. 2013-049832, paragraphs 0011 to 0018 and 0021, with regard to organic tertiary amines. Reference can be made to the same publication, paragraphs 0022 to 0024 and 0027 with regard to the formula of a composition for increasing the dispersion of carbon black by means of an organic tertiary amine. The content of the above publication is expressly incorporated herein by reference in its entirety.

<4. Backcoat Layer>

The magnetic tape of an aspect of the present invention comprises a backcoat layer on the opposite surface of the nonmagnetic support from the surface on which the nonmagnetic layer and magnetic layer are present. The backcoat layer comprises at least nonmagnetic powder, lubricant, and binder, and can also contain any known additives. Reference can be made to the description set forth above in regard to the nonmagnetic powder in the nonmagnetic layer for the nonmagnetic powder in the backcoat layer. It is desirable for carbon black and nonmagnetic powder other than carbon black to be employed in combination, or for carbon black to be employed, as the nonmagnetic powder in the backcoat layer. The formula for the magnetic layer and/or the nonmagnetic layer can be applied for the binder and various additives for forming the backcoat layer.

A backcoat layer containing binder in the form of nitrocellulose is disclosed in Examples of Japanese Unexamined Patent Publication (KOKAI) No. 2009-283082. Nitrocellulose tends to readily dissolve lubricants. Thus, the proportion of the binder accounted for by nitrocellulose contained in the backcoat layer is desirably kept low to increase the water contact angle of the surface of the backcoat layer. Raising the proportion tends to lower the water contact angle of the surface of the backcoat layer. From the perspective of controlling the water contact angle of the surface of the backcoat layer to within the range set forth above, the content of nitrocellulose in the backcoat layer is desirably 0.00 to 1.00 weight parts, preferably 0.00 to 0.50 weight parts per 100.00 weight parts of nonmagnetic powder contained in the backcoat layer. It is even more preferable for no nitrocellulose to be contained in the backcoat layer. The desirable range of the nitrocellulose content per 100.00 weight parts of ferromagnetic powder in the magnetic layer and that of the nitrocellulose content per 100.00 weight parts of nonmagnetic powder in the nonmagnetic layer are identical.

As described above for the nonmagnetic powder in the nonmagnetic layer, carbon black has less of a tendency to adsorb lubricant than various nonmagnetic powders. A tendency by the nonmagnetic powder contained in the backcoat layer not to adsorb lubricant relates to increasing the water contact angle of the surface of the backcoat layer. Conversely, lowering the proportion accounted for by carbon black on the nonmagnetic powder contained in the backcoat layer relates to lowering the water contact angle of the surface of the backcoat layer. Accordingly, one way of controlling the water contact angle of the surface of the backcoat layer is desirably to adjust the proportion accounted for by carbon black in the nonmagnetic powder in the backcoat layer. In one embodiment, the proportion accounted for by carbon black is desirably 1.00 to 30.00 weight parts, preferably 5.00 to 30.00 weight parts, and more preferably, 10.00 to 30.00 weight parts, per 100.00 weight parts of the total quantity of nonmagnetic powder in the backcoat layer.

Reference can be made to the description given above for the magnetic layer in regard to lubricants contained in the backcoat layer. An example of one method for raising the water contact angle of the surface of the backcoat layer is to incorporate in the backcoat layer a lubricant that tends to migrate from the interior of the backcoat layer to the surface of the backcoat layer in the form of a fatty acid. The backcoat layer preferably contains a fatty acid and one or more fatty acid derivatives; preferably contains a fatty acid and one or more selected from the group consisting of fatty acid esters and fatty acid amides; and still more preferably contains one or more fatty acids, one or more fatty acid esters, and one or more fatty acid amides. The quantity of lubricant contained in the backcoat layer is, for example, 0.30 to 15.00 weight parts, desirably 1.00 to 8.00 weight parts, and preferably, 2.00 to 4.00 weight parts, per 100.00 weight parts of nonmagnetic powder contained in the backcoat layer.

<5. Nonmagnetic Support>

Details of the nonmagnetic support will be described next. Examples of nonmagnetic supports are known supports such as biaxially stretched polyethylene terephthalate, polyethylene naphthalate, polyamide, polyamide-imide, and aromatic polyamide. Of these, polyethylene terephthalate, polyethylene naphthalate, and polyamide are desirable.

These supports can be subjected to corona discharge, plasma treatment, adhesion-enhancing treatment, heat treatment and the like in advance.

<6. Thickness of the Various Layers and Nonmagnetic Support>

The thickness of the nonmagnetic support is desirably 3.00 to 80.00 μm, preferably 3.00 to 50.00 μm, and more preferably, 3.00 to 10.00 μm.

The thickness of the magnetic layer can be optimized based on the saturation magnetization level and head gap length of the magnetic head employed, and the bandwidth of the recording signal. 0.01 to 0.10 μm is desirable, and 0.02 to 0.09 μm is preferable, for high density recording. At least one magnetic layer will suffice. The magnetic layer can be separated into two or more having different magnetic characteristics, and a known multilayer magnetic layer configuration can be applied.

The thickness of the nonmagnetic layer is, for example, greater than or equal to 0.05 μm, desirably greater than or equal to 0.07 μm, and preferably, greater than or equal to 0.10 μm. The thickness of the nonmagnetic layer is desirably less than or equal to 0.50 μm, preferably less than or equal to 0.30 μm. To increase the recording capacity per magnetic cartridge, it is desirable to reduce the overall thickness of the magnetic tape. A thin nonmagnetic layer relates to reducing the overall thickness and is thus desirable. When the thickness of a nonmagnetic layer that can function as a tank to supply lubricant to the magnetic layer is reduced, the quantity of lubricant that is supplied by the nonmagnetic layer to the magnetic layer tends to be reduced. However, it is possible to achieve good running durability in a magnetic tape with a nonmagnetic layer the thickness of which has been reduced by keeping the water contact angle of the surface of the magnetic layer and the water contact angle of the surface of the backcoat layer to within the respective ranges set forth above.

The nonmagnetic layer in the present invention includes an essentially nonmagnetic layer containing trace quantities of ferromagnetic powder, for example, either as impurities or intentionally, in addition to the nonmagnetic powder. The essentially nonmagnetic layer means a layer exhibiting a residual magnetic flux density of equal to or less than 10 mT, a coercive force of equal to or less than 7.96 kA/m (100 Oe), or a residual magnetic flux density of equal to or less than 10 mT and a coercive force of equal to or less than 7.96 kA/m (100 Oe). The nonmagnetic layer desirably has no residual magnetic flux density or coercive force.

The backcoat layer is desirably equal to or less than 0.90 μm, preferably 0.10 to 0.70 μm in thickness.

The thickness of the various layers of the magnetic recording medium and the nonmagnetic support can be determined by known film thickness measuring methods. As an example, a cross-section in the direction of thickness of the magnetic recording medium can be exposed by a known technique such as an ion beam or microtome, and the exposed cross-section can be observed with a scanning electron microscope. The various thicknesses can be determined at one spot in the direction of thickness by cross-section observation, or as the arithmetic averages of thicknesses determined at two or more spots. The thickness of each layer can also be determined as the design thickness calculated from the manufacturing conditions.

<7. Surface Roughness of the Magnetic Layer>

From the perspective of achieving higher density recording, in one embodiment of the magnetic tape of an aspect of the present invention, the centerline average surface roughness Ra as measured by an atomic force microscope on the surface of the magnetic layer is desirably less than or equal to 3.0 nm, preferably less than or equal to 2.7 nm, and more preferably, less than or equal to 2.5 nm. For example, the centerline average surface roughness Ra as measured by an atomic force microscope on the surface of the magnetic layer is desirably greater than or equal to 1.0 nm. However, as set forth above, the less rough the surface of the magnetic layer becomes and the smoother the surface of the magnetic layer becomes, the greater the friction during sliding of the surface of the magnetic layer and the head becomes and the greater the tendency of running durability to decrease. Even in such cases, it is possible to achieve good running durability by controlling the water contact angle of a surface of the magnetic layer and the water contact angle of a surface of the backcoat layer to within the above ranges.

The centerline average surface roughness Ra as measured by an atomic force microscope refers to the centerline average surface roughness Ra as measured over a region with an area of 40 μm×40 μm on the surface of the magnetic layer. An example of an atomic force microscope is the NANO SCOPE (Japanese registered trademark) III made by Digital Instruments Corp. employed in contact mode.

The surface roughness of the magnetic layer can be reduced by increasing the dispersion of the various components in the magnetic layer and nonmagnetic layer. It can also be reduced by surface treating the magnetic layer. For example, it is possible to use one, or combine two or more of the various means described in Japanese Unexamined Patent Publication (KOKAI) No. 2010-231843, paragraphs 0022 to 0030, including employing the above-described additives (dispersing agents) to increase dispersion of ferromagnetic powder, carbon black, and abrasives; adjusting the dispersion conditions of the composition (coating liquid) for forming the magnetic layer; and surface treating the magnetic layer.

Further, a polishing treatment employing the polishing means described in Japanese Unexamined Patent Publication (KOKAI) Heisei No. 5-62174 can be used as a surface treatment for the magnetic layer. Reference can be made to paragraphs 0005 to 0032 and all of the drawings of the same publication with regard to the surface treatment. For example, surface treatment of the magnetic layer can also be conducted by the surface treatment (the embodiment shown in FIGS. 1 to 3 of the same publication) based on the diamond wheel that is described in Japanese Unexamined Patent Publication (KOKAI) Heisei No. 5-62174.

The contents of the above publications are expressly incorporated herein by reference in their entirety.

<8. Process of Manufacturing Magnetic Tape>

The magnetic tape of an aspect of the present invention is a particulate magnetic recording medium and can be manufactured using compositions (coating liquids) for forming various layers such as the magnetic layer, nonmagnetic layer, and backcoat layer. A specific form of the process of manufacturing the magnetic tape will be described below. However, in the magnetic tape of an aspect of the present invention, the water contact angle of the surface of the magnetic layer and the water contact angle of the surface of the backcoat layer need only fall within the ranges set forth above, and there is no limitation to a magnetic tape that is manufactured by the manufacturing process of the form given below.

(8-1. Compositions for Forming Various Layers and Preparation Method)

The composition (coating liquid) for forming the magnetic layer normally contains a solvent in addition to the various components described above. Examples of the solvent are those organic solvents that are commonly employed to manufacture particulate magnetic tapes. The content of the solvent in the composition for forming the magnetic layer, for example, falls within a range of 100.0 to 800.0 weight parts, desirably within a range of 200.0 to 600.0 weight parts, per 100.0 weight parts of ferromagnetic powder.

The process of preparing the composition for forming the magnetic layer, and the compositions for forming various layers such as the nonmagnetic layer and backcoat layer, normally comprises a kneading step, dispersing step, and mixing steps provided before and after these steps as needed. Any of these steps can be divided into two or more stages. All of the starting materials, such as ferromagnetic powder, nonmagnetic powder, binder, carbon black, various additives, and solvents can be added at the beginning of, or during, any step. The various starting materials can be separately added in two or more steps. The composition for forming the magnetic layer is desirably prepared by separately preparing a dispersion (magnetic liquid) containing ferromagnetic powder, a dispersion (protrusion-forming agent liquid) containing a protrusion-forming agent (nonmagnetic filler 1), and a dispersion (abrasive liquid) containing abrasive (nonmagnetic filler 2), and then simultaneously or successively mixing them with other components such as lubricants. Part or all of the lubricants, curing agents, and solvents can be added to a mixed liquid obtained by mixing the magnetic liquid, protrusion-forming agent liquid, and abrasive liquid. Additionally, reference can be made to Japanese Unexamined Patent Publication (KOKAI) No. 2010-231843, paragraph 0065, with regard to preparation of the compositions for forming the various layers. The content of the above publication is expressly incorporated herein by reference in its entirety.

The nonmagnetic layer can be formed by, for example, directly coating the composition (coating liquid) for forming the nonmagnetic layer on the surface of a nonmagnetic support. In addition to the various components set forth above, the composition for forming the nonmagnetic layer normally contains a solvent. Examples of solvents are the organic solvents that are commonly used to manufacture particulate magnetic tape. Reference can be made to the above description relating to the composition for forming the magnetic layer for additional details about preparing the composition for forming the nonmagnetic layer.

Reference can also be made to the description given above regarding the composition for forming the magnetic layer in regard to details on preparing the composition (coating liquid) for forming the backcoat layer.

(8-2. Coating Step)

The magnetic layer can be formed by successively or simultaneously multilayer coating the composition for forming the magnetic layer and the composition for forming the nonmagnetic layer. The backcoat layer can be formed by coating the composition for forming the backcoat layer on the opposite surface of the nonmagnetic support from the surface on which the magnetic layer and the nonmagnetic layer are formed.

Reference can be made to Japanese Unexamined Patent Publication (KOKAI) No. 2010-231843, paragraph 66, for details regarding coatings to form the various layers. The content of the above publication is expressly incorporated herein by reference in its entirety.

(8-3. Other Steps)

Reference can be made to Japanese Unexamined Patent Publication (KOKAI) No. 2010-231843, paragraphs 0067 to 0070, for various other steps in manufacturing a magnetic tape. Reference can be made to Japanese Unexamined Patent Publication (KOKAI) Heisei No. 5-62174, as set forth above, regarding surface treatment of the surface of the magnetic layer. The contents of the above publications are expressly incorporated herein by reference in their entirety.

The magnetic tape of an aspect of the present invention as set forth above can exhibit a high SNR even after repeated running. This is presumed to be because it is possible to inhibit the generation of head deposits (of lubricant and shavings from the magnetic layer surface and head) that cause spacing loss in contact sliding type magnetic recording and reproduction systems in which the surface of the magnetic layer slides against the surface of the head during the recording and reproduction of signals.

### EXAMPLES

The present invention will be described in detail below based on Examples. However, the present invention is not limited to embodiments shown in Examples. The terms “parts” and “percent” given in Examples are weight parts and weight percent unless otherwise stated.

<I. Example of Synthesizing Polyalkyleneimine Polymer A>

The acid values and amine values given below were determined by the electrical potential method (solvent: tetrahydrofuran/water=100/10 (volumetric ratio), titration solution: 0.01 N (0.01 mol/L) sodium hydroxide aqueous solution (acid value), 0.01 N (0.01 mol/L) hydrochloric acid (amine value)).

The number average molecular weight and weight average molecular weight were measured by GPC and converted to standard polystyrene conversion values.

The various measurement conditions for the average molecular weight of polyester, polyalkyleneimine, and polyalkyleneimine polymer were as given below.

(Measurement conditions for average molecular weight of polyester)

Measurement apparatus: HLC-8220 GPC (made by Tosoh Corp.)

Column: TSKgel Super HZ 2000/TSKgel Super HZ 4000/TSKgel Super HZ-H (made by Tosoh Corp.)

Eluent: Tetrahydrofuran (THF)

Flow rate: 0.35 mL/min

Column temperature: 40° C.

Detector: Differential refractive (RI) detector

(Measurement conditions for average molecular weight of polyalkyleneimine and average molecular weight of polyalkyleneimine polymer)

Measurement apparatus: HLC-8320 GPC (made by Tosoh Corp.)

Column: Three TSKgel Super AWM-Hs (made by Tosoh Corp.)

Eluent: N-methyl-2-pyrrolidone (with 10 mM lithium bromide added as additive)

Flow rate: 0.35 mL/min

Column temperature: 40° C.

Detector: RI

The number average molecular weight of the polyalkyleneimine chain can be determined by the following method.

Synthesized polyalkyleneimine polymer is hydrolyzed by an ester hydrolysis method such as the acid hydrolysis method described in “Experimental Chemistry Lecture 16 Synthesis of Organic Compounds IV-Carboxylic Acids.Amino Acids.Peptides (5th Ed.),” (compiled by the Chemical Society of Japan, Maruzen Publishing, released March 2005), on page 11. Polyalkyleneimine is separated by liquid chromatography from the hydrolysis product obtained, and the number average molecular weight measured under the above measurement conditions can be adopted as the number average molecular weight of the polyalkyleneimine contained in the polyalkyleneimine polymer.

(Synthesis of Polyester (i-1))

In a 500 mL, three-necked flask were mixed 16.8 g of carboxylic acid in the form of n-octanoic acid (Wako Pure Chemical Industries, Ltd.), 100 g of lactone in the form of s-caprolactone (Praxel M made by Daicel Chemical Industries, Inc.), and 2.2 g of catalyst in the form of monobutyltin oxide (Wako Pure Chemical Industries, Ltd.) (C₄H₉Sn(0)OH) and the mixture was heated for 1 hour at 160° C. A 100 g quantity of ε-caprolactone was added dropwise over 5 hours and the mixture was stirred for another two hours. Subsequently, the mixture was cooled to room temperature, yielding polyester (i−1).

The synthesis schema is indicated below.

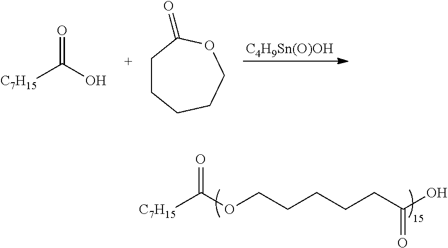

The number average molecular weight and weight average molecular weight of the polyester obtained are given in Table 1 below. The number of units of lactone repeating unit that was calculated from the starting material charge ratio is also given in Table 1.

(Synthesis of Polyalkyleneimine (Polyethyleneimine) Polymer A)

A 2.4 g quantity of polyethyleneimine (SP-006, made by Nippon Shokubai Co., number average molecular weight 600) and 100 g of polyester (i−1) were mixed and heated for 3 hours at 110° C., yielding polyethyleneimine polymer.

Based on the results of two forms of NMR analysis, ¹H-NMR and ¹³C-NMR, and on the results of elemental analysis by the combustion method conducted on the polyalkyleneimine polymer that was obtained, the ratio (polyalkyleneimine chain ratio) accounted for by the polyalkyleneimine chain in the polyalkyleneimine polymer was calculated. The results are given in Table 1. The calculated polyalkyleneimine chain ratio was the same value as the value calculated from the quantities of polyalkyleneimine and polyester charged.

TABLE 1

| | | | Quantity of | | Weight | Number | Number of |
|---|---|---|---|---|---|---|---|
| | | | carboxylic | | average | average | repeating |
| | | Carboxylic | acid | | molecular | molecular | lactone |
| | Polyester | acid | charged (g) | Lactone | weight | weight | units |
| Synthesis of | (i-1) | n-octanoic | 16.8 | ε- | 7,000 | 5,800 | 15 |
| polyester | | acid | | caprolactone | | | |

| | Quantity | Polyalkyleneimine | | | | Weight |
|---|---|---|---|---|---|---|
| | of poly- | chain (poly- | | Acid | Amine | average |
| | ethyleneimine | ethyleneimine | | value | value | molecular |
| | charged (g) | chain) ratio | Polyester | (mgKOH/g) | (mgKOH/g) | weight |
| Synthesis of | 2.4 | 2.3 | (i-1) | 35.0 | 17.4 | 7,000 |
| polyalkyleneimine | | | | | | |
| (polyethyleneimine) | | | | | | |
| polymer | | | | | | |

<II. Examples of Fabricating Magnetic Tape>

### Example 1

(Composition for forming magnetic layer)
(Magnetic liquid)

| | | |
|---|---|---|
| Ferromagnetic barium ferrite powder: | 100.00 | parts |
| (Hc: 175 kA/m (2,200 Oe); average particle size: 27 nm) | | |
| Oleic acid: | 1.50 | parts |
| Polyalkyleneimine polymer A: | 10.00 | parts |
| Vinyl chloride copolymer (MR-104 made by Zeon | 10.00 | parts |
| Corp.): | | |
| SO₃Na group-containing polyurethane resin: | 4.00 | parts |
| Methyl ethyl ketone: | 150.00 | parts |
| Cyclohexanone: | 150.00 | parts |

(Abrasive liquid)

| | | |
|---|---|---|
| Nonmagnetic filler 2 (α-alumina (square-shaped), | 6.00 | parts |
| average particle size: 100 nm, specific | | |
| surface area by BET method: 19 m²/g): | | |
| SO₃Na group-containing polyurethane resin: | 0.60 | part |
| 2,3-Dihydroxynaphthalene: | 0.20 | part |
| Cyclohexanone: | 23.00 | parts |

(Protrusion-forming agent liquid)

| | | |
|---|---|---|
| Nonmagnetic filler 1 (colloidal silica, average | 2.00 | parts |
| particle size: 130 nm): | | |
| Methyl ethyl ketone: | 8.00 | parts |

(Lubricant and curing agent liquid)

| | | |
|---|---|---|
| Stearic acid: | 2.50 | parts |
| Amide stearate: | 0.30 | part |
| Butyl stearate: | 6.00 | parts |
| Methyl ethyl ketone: | 110.00 | parts |
| Cyclohexanone: | 100.00 | parts |
| Polyisocyanate (Coronate (Japanese registered | 2.50 | parts |
| trademark) L, made by Nippon Polyurethane | | |
| Industry Co., Ltd.): | | |

(Composition A for forming nonmagnetic layer)

| | | |
|---|---|---|
| Carbon black (average primary particle size: 16 nm; | 100.00 | parts |
| dibutyl phthalate (DBP) oil | | |
| Absorption capacity: 74 cm³/100 g): | | |
| Trioctylamine: | 3.00 | parts |
| Vinyl chloride copolymer (MR-104, made by Zeon | 19.00 | parts |
| Corp.): | | |
| SO₃Na group-containing polyurethane resin: | 12.00 | parts |
| Polyisocyanate (Coronate L, made by Nippon | 5.00 | parts |
| Polyurethane Industry Co., Ltd.) | | |
| Methyl ethyl ketone: | 370.00 | parts |
| Cyclohexanone: | 370.00 | parts |
| Stearic acid: | 1.50 | parts |
| Amide stearate: | 0.30 | part |
| Butyl stearate: | 1.50 | parts |

(Composition for forming backcoat layer)

| | | |
|---|---|---|
| α-Iron oxide: | 80.00 | parts |
| Carbon black (average primary particle size: 16 nm; DBP | 20.00 | parts |
| oil absorption capacity: 74 cm³/100 g): | | |
| Phenylphosphonic acid: | 3.00 | parts |
| Vinyl chloride copolymer (MR-104, made by Zeon | 12.00 | parts |
| Corp.): | | |
| SO₃Na group-containing polyurethane resin: | 8.00 | parts |
| Alumina powder (α-alumina with specific surface | 5.00 | parts |
| area of 17 m²/g): | | |
| Polyisocyanate (Coronate L made by Nippon | 5.00 | parts |
| Polyurethane Industry Co., Ltd.): | | |
| Methyl ethyl ketone: | 600.00 | parts |
| Toluene: | 600.00 | parts |
| Stearic acid: | 1.00 | part |
| Amide stearate: | 0.30 | part |
| Butyl stearate: | 1.50 | parts |

(Preparation of Composition for Forming the Magnetic Layer)

The composition for forming the magnetic layer was prepared by the following method.

The above magnetic liquid was kneaded and dilution processed in an open kneader, and then subjected to 30 passes of dispersion treatment with a single pass residence time of 2 minutes, rotor tip peripheral speed of 10 m/s, and bead fill rate of 80% using zirconia (ZrO₂) beads (referred to as “Zr beads” hereinafter) with a 0.1 mm particle diameter in a horizontal bead mill disperser.

For the abrasive liquid, the above components were mixed and the mixture was charged along with Zr beads 0.3 mm in bead diameter to a horizontal bead mill disperser. Adjustment was made to achieve a bead volume/(abrasive liquid volume+bead volume) of 80% and bead mill dispersion processing was conducted for 120 minutes. Following processing, the liquid was collected and subjected to ultrasonic dispersion filtration processing using a flow-type ultrasonic dispersion filtration device.

The magnetic liquid, protrusion-forming agent liquid, and abrasive liquid were placed along with other components in the form of the lubricant and curing liquid in a dissolver stirrer, and stirred for 30 minutes at a peripheral speed of 10 m/s. Subsequently, the liquid was subjected to 3 passes at a flow rate of 7.5 kg/minute through a flow-type ultrasonic disperser and filtered through a 1 μm filter to prepare the composition for forming the magnetic layer.

(Preparation of Composition for Forming Nonmagnetic Layer)

The composition for forming the nonmagnetic layer was prepared by the following method.

Excluding the lubricants (stearic acid, amide stearate, and butyl stearate) and polyisocyanate, the above components were kneaded and dilution processed in an open kneader. Subsequently, the mixture was dispersion processed in a horizontal bead mill disperser. Subsequently, the lubricants (stearic acid, amide stearate, and butyl stearate) and polyisocyanate were added and stirring and mixing were conducted in a dissolver stirrer to prepare the composition for forming the nonmagnetic layer.

(Preparation of Composition for Forming Backcoat Layer)

The composition for forming the backcoat layer was prepared by the following method.

Excluding the polyisocyanate and lubrications (stearic acid, amide stearate, and butyl stearate), the above components were charged to a dissolver stirrer and stirred for 30 minutes at a peripheral speed of 10 m/s. They were then dispersion processed in a horizontal bead mill disperser. Subsequently, the polyisocyanate and lubricants (stearic acid, amide stearate, and butyl stearate) were added, and the mixture was stirred and mixed in the dissolver stirrer to prepare the composition for forming the backcoat layer.

(Fabrication of Magnetic Tape)

The composition for forming the nonmagnetic layer was coated and dried to a dry thickness of 0.10 μm on one surface of a nonmagnetic support (polyethylene naphthalate support) 6.00 μm in thickness. The composition for forming the backcoat layer was then coated and dried to a dry thickness of 0.50 μm on the other side of the nonmagnetic support. After being wound on a pickup roll, the support was heat treated for 36 hours in a 70° C. environment.

Following the heat treatment, the composition for forming the magnetic layer was coated and dried to a dry thickness of 0.07 μm on the nonmagnetic layer.

Subsequently, a surface smoothing treatment (calendering treatment) was conducted at a temperature of 100° C., linear pressure of 300 kg/cm (294 kN/m), and speed of 40 m/min using a calendar comprised of only metal rolls. Subsequently, a heat treatment was conducted for 36 hours in an environment of 70° C. Following the heat treatment, the product was slit to ½ inch width. The surface of the magnetic layer was cleaned with a tape cleaning device in which a nonwoven cloth and a razor blade were mounted so as to press against the surface of the magnetic layer on a device having slit product feeding and pickup devices. Subsequently, the magnetic tape obtained was wound on a reel into a roll, and the properties thereof were evaluated by the evaluation methods set forth below.

The thickness of the various layers in the present Example as well as in Examples and Comparative Examples set forth further below are design thicknesses calculated from the manufacturing conditions.

<Evaluation Methods>

### (Measurement of the Water Contact Angles of the Surface of the Magnetic Layer and the Surface of the Backcoat Layer)

The contact angle was measured by the following method with a Drop Master 700 contact angle measuring device made by Kyowa Interface Science Co., Ltd.

A tape sample that had been obtained by cutting a prescribed length from the end of a roll of magnetic tape that had been wound into a roll was positioned on a slide glass so that the surface of the backcoat layer was in contact with the surface of the slide glass. A 2.0 μL quantity of measurement liquid (water) was dripped onto the surface of the tape sample (surface of the magnetic layer) and left standing for a droplet stabilization period of one second. The contact angle analysis software FAMAS that came with the contact angle measuring device was then used to analyze an image of the droplet and measure the contact angle of the tape sample and the droplet. The contact angle was calculated by the θ/2 method. Six measurements were taken for each sample, and the average value (arithmetic average) was adopted as the contact angle. Measurement was conducted in an environment of 20° C. at 25% relative humidity and the water contact angel of the surface of the magnetic layer was obtained under the following analysis conditions.

A new tape sample was cut from the same roll of magnetic tape and placed on a slide glass with the surface of the magnetic layer in contact with the surface of the slide glass. The water contact angle of the surface of the backcoat layer was then obtained by the same method as that set forth above.

Method: Liquid drop method (θ/2 method)

Recognition of liquid attachment: automatic

Liquid attachment recognition line (distance from top of needle): 50 dot

Algorithm: automatic

Image mode: frame

Threshold level: automatic

(Evaluation of running durability)

The amount of change in SNR following repeated running was measured by the following method. Measurements were made with a ½ inch linear system in which the head was fixed. The relative head/tape speed was 5 m/s. Recording was made with a ring head with a saturation magnetization of 1.6 T (track width: 18 μm). The recording current was set to the optimal current for each tape. An anisotropic magnetoresistive head (A-MR) with an element thickness of 25 nm and a shield gap of 0.2 μm was employed as the reproduction head.

A signal was recorded at a recording wavelength of 0.2 μm and the reproduced signal was frequency analyzed with a spectrum analyzer made by Advantest. The ratio of the carrier signal (wavelength 0.2 μm) output to the noise integrated over the entire spectral region was adopted as the S/N ratio.

While monitoring the output of the carrier signal (wavelength 0.2 μm), 10,000 repeated passes of the magnetic tapes of Examples and Comparative Examples were made, with each pass being 800 m. The SNR of the first pass (initial SNR) was made 0 dB, and the amount of change in the SNR after making 10,000 passes (initial SNR-SNR after making 10,000 passes) was calculated. The running durability was evaluated on the following evaluation scale.

### Evaluation Scale

A: 1 dB of change in SNR after making 10,000 passes
B: 2 dB of change in SNR after making 10,000 passes
C: greater than 2 dB of change in SNR after making 10,000 passes

### Examples 2 to 10, Comparative Examples 1 to 5

Magnetic tapes were fabricated and evaluated in the same manner as in Example 1 with the exceptions that the types and average particle sizes of nonmagnetic fillers 1 and 2 in the composition for forming the magnetic layer; the formulated quantities of vinyl chloride copolymer, polyurethane resin in the magnetic liquid and stearic acid of the composition for forming the magnetic layer; the formulated quantities of the α-iron oxide, carbon black, polyurethane resin, vinyl chloride copolymer, nitrocellulose, and stearic acid in the composition for forming the backcoat layer; and the thickness of the nonmagnetic layer were as indicated in Table 2.

### Example 11

With the exception that the protrusion-forming agent liquid of the composition for forming the magnetic layer was changed to that indicated below and prepared by the following method, a magnetic tape was fabricated and evaluated by the same method as in Example 1.

(Protrusion-forming agent (carbon black) liquid)

| | |
|---|---|
| Nonmagnetic filler 1 (carbon black, average primary | 0.50 parts |
| particles size: 130 nm): | |
| Trioctylamine: | 0.05 part |
| Cyclohexanone: | 4.50 parts |

### (Preparation of Carbon Black Liquid)

The carbon black liquid was prepared by the following processing method. Liquefaction processing was conducted by 6 hours of ultrasonic processing at a stirring rotational speed of 1,500 rpm in a batch-type ultrasonic dispersing device equipped with stirrer. The carbon black liquid that had been liquefied was subjected to 6 passes of dispersion processing at a single pass retention time of 2 minutes, a rotor tip peripheral speed of 10 m/s, and a bead fill rate of 80% using Zr beads with a particle diameter of 0.5 mm in a horizontal bead mill disperser. The liquid was stirred for 30 minutes at a peripheral speed of 10 m/s in a dissolver-stirrer and then subjected to 3 passes at a flow rate of 3 kg/min through a flow-type ultrasonic disperser.

### Comparative Example 6

A magnetic tape was fabricated and evaluated in the same manner as in Example 11 with the exceptions that the types and average particle sizes of nonmagnetic fillers 1 and 2 in the composition for forming the magnetic layer; the formulated quantities of vinyl chloride copolymer, polyurethane resin in the magnetic liquid and stearic acid of the composition for forming the magnetic layer; the formulated quantities of the α-iron oxide, carbon black, polyurethane resin, vinyl chloride copolymer, nitrocellulose, and stearic acid in the composition for forming the backcoat layer; the thickness of the nonmagnetic layer were as indicated in Table 2, and that no polyalkyleneimine polymer A was added to the composition for forming the magnetic layer.

The results are given in Table 2. The centerline average surface roughness Ra of the surface of the magnetic layer was measured by the method set forth above using a NANOSCOPE III made by Digital Instruments Corp. in contact mode as an atomic force microscope for the magnetic tapes of Examples. As a result, the surface smoothness of the magnetic layer was found to be good for the tapes of Examples, which all fell within a range of 2.0 to 2.5 nm.

TABLE 2

| | | Ex. 1 | Ex. 2 | Ex. 3 | Ex. 4 | Ex. 5 |
|---|---|---|---|---|---|---|
| Magnetic | Type of nonmagnetic filler 1 | Colloidal | Colloidal | Colloidal | Colloidal | Colloidal |
| layer | | silica | silica | silica | silica | silica |
| | Average particle size of | 130 | 130 | 130 | 130 | 130 |
| | nonmagnetic filler 1 | | | | | |
| | φ 1(nm) | | | | | |
| | Type of nonmagnetic filler 2 | α-alumina | α-alumina | α-alumina | α-alumina | α-alumina |
| | Average particle size of | 100 | 100 | 100 | 100 | 100 |
| | nonmagnetic filler 2 | | | | | |
| | φ 2(nm) | | | | | |
| | φ 1 − φ 2(nm) | 30 | 30 | 30 | 30 | 30 |
| | Polyalkyleneimine polymer A | Present | Present | Present | Present | Present |
| | Formulated quantity of | 10.00 | 10.00 | 10.00 | 10.00 | 10.00 |
| | vinyl chloride copolymer | | | | | |
| | (weight parts) | | | | | |
| | Formulated quantity of | 4.00 | 4.00 | 4.00 | 4.00 | 4.00 |
| | polyurethane resin | | | | | |
| | (weight parts) | | | | | |
| | Formulated quantity of | 2.50 | 3.00 | 2.00 | 2.50 | 2.50 |
| | stearic acid | | | | | |
| | (weight parts) | | | | | |
| | Water contact angle | 97° | 99° | 95° | 99° | 95° |
| Nonmagnetic | Thickness(μm) | 0.10 | 0.10 | 0.10 | 0.10 | 0.10 |
| layer | | | | | | |
| Backcoat | Formulated quantity of | 80.00 | 80.00 | 80.00 | 80.00 | 80.00 |
| layer | α-iron oxide | | | | | |
| | (weight parts) | | | | | |
| | Formulated quantity of | 20.00 | 20.00 | 20.00 | 20.00 | 20.00 |
| | carbon black | | | | | |
| | (weight parts) | | | | | |
| | Formulated quantity of | 8.00 | 8.00 | 8.00 | 8.00 | 8.00 |
| | polyurethane resin | | | | | |
| | (weight parts) | | | | | |
| | Formulated quantity of | 12.00 | 12.00 | 12.00 | 12.00 | 12.00 |
| | vinyl chloride copolymer | | | | | |
| | (weight parts) | | | | | |
| | Formulated quantity of | 0.00 | 0.00 | 0.00 | 0.00 | 0.00 |
| | nitrocellulose | | | | | |
| | (weight parts) | | | | | |
| | Formulated quantity of | 1.00 | 1.00 | 1.00 | 2.00 | 0.70 |
| | stearic acid | | | | | |
| | (weight parts) | | | | | |
| | Water contact angle | 97° | 98° | 96° | 100° | 95° |

| | | | | | |
|---|---|---|---|---|---|
| Runninu durability | A | A | A | A | A |
| (change in SNR after repeated running) | | | | | |

| | | Ex. 6 | Ex. 7 | Ex. 8 | Ex. 9 | Ex. 10 | Ex. 11 |
|---|---|---|---|---|---|---|---|
| Magnetic | Type of nonmagnetic filler 1 | Colloidal | Colloidal | Colloidal | Colloidal | Colloidal | Carbon |
| layer | | silica | silica | silica | silica | silica | black |
| | Average particle size of | 130 | 120 | 130 | 100 | 150 | 130 |
| | nonmagnetic filler 1 | | | | | | |
| | φ 1(nm) | | | | | | |
| | Type of nonmagnetic filler 2 | SiC | α-alumina | α-alumina | α-alumina | α-alumina | α-alumina |
| | Average particle size of | 100 | 100 | 80 | 100 | 80 | 100 |
| | nonmagnetic filler 2 | | | | | | |
| | φ 2(nm) | | | | | | |
| | φ 1 − φ 2(nm) | 30 | 20 | 50 | 0 | 70 | 30 |
| | Polyalkyleneimine polymer A | Present | Present | Present | Present | Present | Present |
| | Formulated quantity of | 10.00 | 10.00 | 10.00 | 10.00 | 10.00 | 10.00 |
| | vinyl chloride copolymer | | | | | | |
| | (weight parts) | | | | | | |
| | Formulated quantity of | 4.00 | 4.00 | 4.00 | 4.00 | 4.00 | 4.00 |
| | polyurethane resin | | | | | | |
| | (weight parts) | | | | | | |
| | Formulated quantity of | 2.50 | 2.50 | 2.50 | 2.50 | 2.50 | 2.50 |
| | stearic acid | | | | | | |
| | (weight parts) | | | | | | |
| | Water contact angle | 97° | 97° | 97° | 97° | 97° | 97° |
| Nonmagnetic | Thickness(μm) | 0.10 | 0.10 | 0.10 | 0.10 | 0.10 | 0.10 |
| layer | | | | | | | |
| Backcoat | Formulated quantity of | 80.00 | 80.00 | 80.00 | 80.00 | 80.00 | 80.00 |
| layer | α-iron oxide | | | | | | |
| | (weight parts) | | | | | | |
| | Formulated quantity of | 20.00 | 20.00 | 20.00 | 20.00 | 20.00 | 20.00 |
| | carbon black | | | | | | |
| | (weight parts) | | | | | | |
| | Formulated quantity of | 8.00 | 8.00 | 8.00 | 8.00 | 8.00 | 8.00 |
| | polyurethane resin | | | | | | |
| | (weight parts) | | | | | | |
| | Formulated quantity of | 12.00 | 12.00 | 12.00 | 12.00 | 12.00 | 12.00 |
| | vinyl chloride copolymer | | | | | | |
| | (weight parts) | | | | | | |
| | Formulated quantity of | 0.00 | 0.00 | 0.00 | 0.00 | 0.00 | 0.00 |
| | nitrocellulose | | | | | | |
| | (weight parts) | | | | | | |
| | Formulated quantity of | 1.00 | 1.00 | 1.00 | 1.00 | 1.00 | 1.00 |
| | stearic acid | | | | | | |
| | (weight parts) | | | | | | |
| | Water contact angle | 97° | 97° | 97° | 97° | 97° | 97° |

| | | | | | | |
|---|---|---|---|---|---|---|
| Runninu durability | A | B | B | B | B | B |
| (change in SNR after repeated running) | | | | | | |

| | | Comp. Ex. 1 | Comp. Ex. 2 | Comp. Ex. 3 | Comp. Ex. 4 | Comp. Ex. 5 | Comp. Ex. 6 |
|---|---|---|---|---|---|---|---|
| Magnetic | Type of nonmagnetic filler 1 | Colloidal | Colloidal | Colloidal | Colloidal | — | Carbon |
| layer | | silica | silica | silica | silica | | black |
| | Average particle size of | 100 | 100 | 130 | 130 | — | 80 |
| | nonmagnetic filler 1 | | | | | | |
| | φ 1(nm) | | | | | | |
| | Type of nonmagnetic filler 2 | α-alumina | α-alumina | α-alumina | α-alumina | α-alumina | α-alumina |
| | Average particle size of | 100 | 100 | 80 | 80 | 80 | 200 |
| | nonmagnetic filler 2 | | | | | | |
| | φ 2(nm) | | | | | | |
| | φ 1 − φ 2(nm) | 0 | 0 | 50 | 50 | — | −120 |
| | Polyalkyleneimine polymer A | Present | Present | Present | Present | Present | — |
| | Formulated quantity of | 10.00 | 10.00 | 10.00 | 10.00 | 13.00 | 9.00 |
| | vinyl chloride copolymer | | | | | | |
| | (weight parts) | | | | | | |
| | Formulated quantity of | 4.00 | 4.00 | 4.00 | 4.00 | 4.50 | 4.50 |
| | polyurethane resin | | | | | | |
| | (weight parts) | | | | | | |
| | Formulated quantity of | 3.50 | 2.50 | 2.50 | 2.50 | — | 0.50 |
| | stearic acid | | | | | | |
| | (weight parts) | | | | | | |
| | Water contact angle | 101° | 91° | 101° | 97° | 99° | 92° |
| Nonmagnetic | Thickness (μm) | 0.10 | 0.10 | 0.10 | 0.10 | 1.00 | 0.10 |
| layer | | | | | | | |
| Backcoat | Formulated quantity of | 80.00 | 80.00 | 80.00 | 0.00 | 10.00 | 85.00 |
| layer | α-iron oxide | | | | | | |
| | (weight parts) | | | | | | |
| | Formulated quantity of | 20.00 | 20.00 | 20.00 | 100.00 | 90.00 | 15.00 |
| | carbon black | | | | | | |
| | (weight parts) | | | | | | |
| | Formulated quantity of | 8.00 | 8.00 | 8.00 | 65.00 | 30.00 | 6.00 |
| | polyurethane resin | | | | | | |
| | (weight parts) | | | | | | |
| | Formulated quantity of | 12.00 | 12.00 | 12.00 | 0.00 | 0.00 | 12.00 |
| | vinyl chloride copolymer | | | | | | |
| | (weight parts) | | | | | | |
| | Formulated quantity of | 0.00 | 0.00 | 0.00 | 27.00 | 45.00 | — |
| | nitrocellulose | | | | | | |
| | (weight parts) | | | | | | |
| | Formulated quantity of | 1.00 | 0.00 | 3.00 | 2.00 | 0.00 | 1.00 |
| | stearic acid | | | | | | |
| | (weight parts) | | | | | | |
| | Water contact angle | 98° | 90° | 102° | 84° | 82° | 94° |

| | | | | | | |
|---|---|---|---|---|---|---|
| Runninu durability | C | C | C | C | C | C |
| (change in SNR after repeated running) | | | | | | |

Based on the results given in Table 2, the magnetic tapes of Examples were found to undergo little drop in SNR following repeated running and to possess good running durability.

An aspect of the present invention is useful in the field of manufacturing magnetic recording media for data storage, such as data backup tapes.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic tape, comprising, on one surface of a nonmagnetic support, a nonmagnetic layer comprising nonmagnetic powder, lubricant, and binder;
comprising, on a surface of the nonmagnetic layer, a magnetic layer comprising magnetic powder, lubricant, and binder; and
comprising, on an opposite surface of the nonmagnetic support from the surface on which the nonmagnetic layer and magnetic layer are present, a backcoat layer comprising nonmagnetic powder, lubricant, and binder, wherein
a contact angle for water of a surface of the magnetic layer ranges from 95° to 100°, and
a contact angle for water of a surface of the backcoat layer ranges from 95° to 100°.

2. The magnetic tape according to claim 1, wherein a thickness of the nonmagnetic layer ranges from 0.05 to 0.50 μm.

3. The magnetic tape according to claim 1, wherein the magnetic layer comprises:
nonmagnetic filler 1 having an average particle size φ1; and
nonmagnetic filler 2 having an average particle size φ2 smaller than φ1 and a Mohs hardness greater than a Mohs hardness of nonmagnetic filler 1;
where φ1 and φ2, each unit of which is nm, satisfy equation 1:
20 nm≦φ1−φ2<50 nm equation 1.

4. The magnetic tape according to claim 2, wherein the magnetic layer comprises:
nonmagnetic filler 1 having an average particle size φ1; and
nonmagnetic filler 2 having an average particle size φ2 smaller than φ1 and a Mohs hardness greater than a Mohs hardness of nonmagnetic filler 1;
where φ1 and φ2, each unit of which is nm, satisfy equation 1:
20 nm≦φ1−φ2<50 nm equation 1.

5. The magnetic tape according to claim 3, wherein nonmagnetic filler 1 is selected from the group consisting of inorganic oxide particles and carbon black.

6. The magnetic tape according to claim 5, wherein nonmagnetic filler 1 comprises colloidal particles.

7. The magnetic tape according to claim 6, wherein nonmagnetic filler 1 comprises colloidal silica.

8. The magnetic tape according to claim 4, wherein nonmagnetic filler 1 is selected from the group consisting of inorganic oxide particles and carbon black.

9. The magnetic tape according to claim 8, wherein nonmagnetic filler 1 comprises colloidal particles.

10. The magnetic tape according to claim 9, wherein nonmagnetic filler 1 comprises colloidal silica.

11. The magnetic tape according to claim 3, wherein nonmagnetic filler 2 is selected from the group consisting of alumina powder and silicon carbide powder.

12. The magnetic tape according to claim 4, wherein nonmagnetic filler 2 is selected from the group consisting of alumina powder and silicon carbide powder.

13. The magnetic tape according to claim 1, wherein a content of nitrocellulose in the backcoat layer ranges from 0.00 to 1.00 weight parts per 100.0 weight parts of the total quantity of the nonmagnetic powder.

14. The magnetic tape according to claim 1, wherein the nonmagnetic powder contained in the backcoat layer comprises inorganic oxide powder and carbon black.

15. The magnetic tape according to claim 14, wherein the nonmagnetic powder contained in the backcoat layer comprises carbon black in a quantity ranging from 1.00 to 30.00 weight parts per 100.00 weight parts of the total quantity of the nonmagnetic powder.

16. The magnetic tape according to claim 1, wherein the nonmagnetic powder contained in the nonmagnetic layer comprises carbon black.

17. The magnetic tape according to claim 1, wherein the lubricant contained in the magnetic layer, the lubricant contained in the nonmagnetic layer, and the lubricant contained in the back coat layer each comprise one or more lubricants selected from the group consisting of fatty acids, fatty acid esters, and fatty acid amides.

18. The magnetic tape according to claim 17, wherein the lubricant contained in the magnetic layer and the lubricant contained in the backcoat layer each comprises one or more fatty acids.
